(19) United States
(12) Patent Application Publication
(10) Pub. No.: US 2025/0317859 A1
(43) Pub. Date: Oct. 9, 2025

(54) LOW POWER WAKEUP SIGNALING

(71) Applicant: QUALCOMM Incorporated, San Diego, CA (US)

(72) Inventors: Jung Ho RYU, Englewood Cliffs, NJ (US); Kazuki TAKEDA, Minato-ku (JP); Jelena DAMNJANOVIC, Del Mar, CA (US); Hemant SAGGAR, San Diego, CA (US); Igor GUTMAN, Hod HaSharon (IL)

(21) Appl. No.: 19/092,983

(22) Filed: Mar. 27, 2025

Related U.S. Application Data
(60) Provisional application No. 63/574,109, filed on Apr. 3, 2024.

(51) Int. Cl. H04W 52/02; H04W 72/1273

(52) U.S. Cl. CPC H04W 52/0235; H04W 72/1273

(57) ABSTRACT

Methods, systems, and devices for wireless communication are described. A wireless device may receive first configuration information that defines a first schedule of occasions for reception of a low power wakeup signal via a first radio of the wireless device associated with low power operation. The wireless device may receive second configuration information that defines a periodic connected-mode discontinuous reception (C-DRX) cycle that includes a second schedule of periodic ON durations to monitor a physical downlink control channel (PDCCH) via a second radio of the wireless device, and receive the low power wakeup signal via the first radio of the wireless device in accordance with the first configuration information and in advance of, by at least a threshold amount, a start of a next ON duration or a next PDCCH message.

### CROSS REFERENCE

The present Application for Patent claims the benefit of U.S. Provisional Patent Application No. 63/574,109 by RYU et al., entitled “LOW POWER WAKEUP SIGNALING”, filed Apr. 3, 2024, which is assigned to the assignee hereof, and is expressly incorporated by reference herein.

### INTRODUCTION

The following relates to wireless communication, including managing wakeup signaling.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support low power wakeup signaling.

A method for wireless communications by a wireless device is described. The method may include receiving first configuration information that defines a first schedule of occasions for reception of a low power wakeup signal via a first radio of the wireless device associated with low power operation, receiving second configuration information that defines a periodic connected-mode discontinuous reception (C-DRX) cycle that includes a second schedule of periodic ON durations to monitor a physical downlink control channel (PDCCH) via a second radio of the wireless device different than the first radio of the wireless device, and receiving the low power wakeup signal via the first radio of the wireless device in accordance with the first configuration information and in advance of, by at least a threshold amount, a start of a next ON duration or a next PDCCH message.

A wireless device for wireless communications is described. The wireless device may include one or more memories storing processor executable code, and one or more processors coupled with the one or more memories. The one or more processors may individually or collectively be operable to execute the code to cause the wireless device to receive first configuration information that defines a first schedule of occasions for reception of a low power wakeup signal via a first radio of the wireless device associated with low power operation, receive second configuration information that defines a periodic C-DRX cycle that includes a second schedule of periodic ON durations to monitor a PDCCH via a second radio of the wireless device different than the first radio of the wireless device, and receive the low power wakeup signal via the first radio of the wireless device in accordance with the first configuration information and in advance of, by at least a threshold amount, a start of a next ON duration or a next PDCCH message.

An apparatus for wireless communication at a UE is described. The apparatus may include one or more memories, and one or more processors coupled with the one or more memories. The one or more processors may be configured to cause the UE to receive first configuration information that defines a first schedule of occasions for reception of a low power wakeup signal via a first radio of the wireless device associated with low power operation, receive second configuration information that defines a periodic C-DRX cycle that includes a second schedule of periodic ON durations to monitor a PDCCH via a second radio of the wireless device different than the first radio of the wireless device, and receive the low power wakeup signal via the first radio of the wireless device in accordance with the first configuration information and in advance of, by at least a threshold amount, a start of a next ON duration or a next PDCCH message.

Another wireless device for wireless communications is described. The wireless device may include means for receiving first configuration information that defines a first schedule of occasions for reception of a low power wakeup signal via a first radio of the wireless device associated with low power operation, means for receiving second configuration information that defines a periodic C-DRX cycle that includes a second schedule of periodic ON durations to monitor a PDCCH via a second radio of the wireless device different than the first radio of the wireless device, and means for receiving the low power wakeup signal via the first radio of the wireless device in accordance with the first configuration information and in advance of, by at least a threshold amount, a start of a next ON duration or a next PDCCH message.

A non-transitory computer-readable medium storing code for wireless communications is described. The code may include instructions executable by one or more processors to receive first configuration information that defines a first schedule of occasions for reception of a low power wakeup signal via a first radio of the wireless device associated with low power operation, receive second configuration information that defines a periodic C-DRX cycle that includes a second schedule of periodic ON durations to monitor a PDCCH via a second radio of the wireless device different than the first radio of the wireless device, and receive the low power wakeup signal via the first radio of the wireless device in accordance with the first configuration information and in advance of, by at least a threshold amount, a start of a next ON duration or a next PDCCH message.

Some examples of the method, wireless devices, user equipments (UEs), and non-transitory computer-readable medium described herein may further include operations, features, means, or instructions for monitoring the PDCCH via the second radio of the wireless device during the next ON duration based on receiving the low power wakeup signal via the first radio of the wireless device and in advance of, by at least the threshold amount, the start of the next ON duration or the next PDCCH message and receiving the next PDCCH message via the second radio of the wireless device during the next ON duration based on the monitoring.

Some examples of the method, wireless devices, user equipments (UEs), and non-transitory computer-readable medium described herein may further include operations, features, means, or instructions for monitoring the PDCCH via the second radio of the wireless device after the next ON duration based on receiving the low power wakeup signal via the first radio of the wireless device within at least the threshold amount of the start of the next ON duration and receiving the next PDCCH message via the second radio of the wireless device during a subsequent ON duration that occurs after the next ON duration.

In some examples of the method, wireless devices, user equipments (UEs), and non-transitory computer-readable medium described herein, the low power wakeup signal includes at least one bit that indicates whether to monitor the PDCCH during the next ON duration.

Some examples of the method, wireless devices, user equipments (UEs), and non-transitory computer-readable medium described herein may further include operations, features, means, or instructions for monitoring the PDCCH via the second radio of the wireless device during the next ON duration based on the at least one bit included in the received low power wakeup signal and refraining from monitoring the PDCCH via the second radio of the wireless device during the next ON duration based on the at least one bit included in the received low power wakeup signal.

Some examples of the method, wireless devices, user equipments (UEs), and non-transitory computer-readable medium described herein may further include operations, features, means, or instructions for monitoring the PDCCH via the second radio of the wireless device during the next ON duration irrespective of at least one bit included in the received low power wakeup signal.

In some examples of the method, wireless devices, user equipments (UEs), and non-transitory computer-readable medium described herein, receiving the low power wakeup signal may include operations, features, means, or instructions for receiving the low power wakeup signal via the first radio of the wireless device in advance of, by at least the threshold amount, the next ON duration, the method further including receiving a tracking reference signal (TRS) via the second radio of the wireless device in accordance with third configuration information and in advance of the next ON duration.

In some examples of the method, wireless devices, user equipments (UEs), and non-transitory computer-readable medium described herein, the third configuration information includes a TRS configuration and the third configuration information may be indicated by the low power wakeup signal.

Some examples of the method, wireless devices, user equipments (UEs), and non-transitory computer-readable medium described herein may further include operations, features, means, or instructions for transmitting a channel state information (CSI) report via the second radio of the wireless device during the next ON duration and irrespective of a timer for C-DRX.

In some examples of the method, wireless devices, user equipments (UEs), and non-transitory computer-readable medium described herein, receiving the low power wakeup signal may include operations, features, means, or instructions for receiving the low power wakeup signal via the first radio of the wireless device in advance of the next ON duration, the method further including monitoring the PDCCH via the second radio of the wireless device for the next PDCCH message based on receiving the low power wakeup signal via the first radio of the wireless device and in advance of the next PDCCH message.

Some examples of the method, wireless devices, user equipments (UEs), and non-transitory computer-readable medium described herein may further include operations, features, means, or instructions for terminating monitoring the PDCCH via the second radio of the wireless device for the next PDCCH message based on an expiration of one or more of an inactivity timer, an ON duration timer for C-DRX, or an expiration of one or more timers associated with the low power wakeup signal.

Some examples of the method, wireless devices, user equipments (UEs), and non-transitory computer-readable medium described herein may further include operations, features, means, or instructions for receiving control signaling from a network entity to terminate monitoring the PDCCH, where the control signaling includes downlink control information (DCI).

In some examples of the method, wireless devices, user equipments (UEs), and non-transitory computer-readable medium described herein, receiving the low power wakeup signal may include operations, features, means, or instructions for receiving the low power wakeup signal via the first radio of the wireless device during an occasion of the first schedule of occasions and in advance of, by at least the threshold amount, the next PDCCH message during a current ON duration of the second schedule of periodic ON durations, the method further including, monitoring the PDCCH via the second radio of the wireless device during the current ON duration and based on receiving the low power wakeup signal in advance of, by at least the threshold amount, the next PDCCH message associated with the current ON duration, and receiving the next PDCCH message via the second radio of the wireless device and during the current ON duration based on the monitoring.

Some examples of the method, wireless devices, user equipments (UEs), and non-transitory computer-readable medium described herein may further include operations, features, means, or instructions for enabling one or more of an inactivity timer or an ON duration timer for C-DRX based on receiving the low power wakeup signal via the first radio of the wireless device.

Some examples of the method, wireless devices, user equipments (UEs), and non-transitory computer-readable medium described herein may further include operations, features, means, or instructions for terminating monitoring the PDCCH via the second radio of the wireless device during the current ON duration based on an expiration of one or more of an inactivity timer or an ON duration timer for C-DRX.

In some examples of the method, wireless devices, user equipments (UEs), and non-transitory computer-readable medium described herein, receiving the low power wakeup signal may include operations, features, means, or instructions for receiving the low power wakeup signal via the first radio of the wireless device during an occasion of the first schedule of occasions and in advance of, by at least the threshold amount, the next PDCCH message during a current ON duration of the second schedule of periodic ON durations, the method further including receiving a TRS via the second radio of the wireless device in accordance with third configuration information and in advance of monitoring the PDCCH for the next PDCCH message during the current ON duration.

In some examples of the method, wireless devices, user equipments (UEs), and non-transitory computer-readable medium described herein, the third configuration information includes a TRS configuration and the third configuration information may be indicated by the low power wakeup signal.

In some examples of the method, wireless devices, user equipments (UEs), and non-transitory computer-readable medium described herein, the low power wakeup signal includes a ON-OFF keying (OOK) waveform.

A method for wireless communications by a network entity is described. The method may include transmitting first configuration information that defines a first schedule of occasions for reception of a low power wakeup signal via a first radio of a wireless device associated with low power operation, transmitting second configuration information that defines a periodic C-DRX cycle that includes a second schedule of periodic ON durations to monitor a PDCCH via a second radio of the wireless device different than the first radio of the wireless device, and transmitting the low power wakeup signal via the first radio of the wireless device in accordance with the first configuration information and in advance of, by at least a threshold amount, a start of a next ON duration or a next PDCCH message.

A network entity for wireless communications is described. The network entity may include one or more memories storing processor executable code, and one or more processors coupled with the one or more memories. The one or more processors may individually or collectively be operable to execute the code to cause the network entity to transmit first configuration information that defines a first schedule of occasions for reception of a low power wakeup signal via a first radio of a wireless device associated with low power operation, transmit second configuration information that defines a periodic C-DRX cycle that includes a second schedule of periodic ON durations to monitor a PDCCH via a second radio of the wireless device different than the first radio of the wireless device, and transmit the low power wakeup signal via the first radio of the wireless device in accordance with the first configuration information and in advance of, by at least a threshold amount, a start of a next ON duration or a next PDCCH message.

An apparatus for wireless communication at a network entity is described. The apparatus may include one or more memories, and one or more processors coupled with the one or more memories and configured to cause the network entity to transmit first configuration information that defines a first schedule of occasions for reception of a low power wakeup signal via a first radio of a wireless device associated with low power operation, transmit second configuration information that defines a periodic C-DRX cycle that includes a second schedule of periodic ON durations to monitor a PDCCH via a second radio of the wireless device different than the first radio of the wireless device, and transmit the low power wakeup signal via the first radio of the wireless device in accordance with the first configuration information and in advance of, by at least a threshold amount, a start of a next ON duration or a next PDCCH message.

Another network entity for wireless communications is described. The network entity may include means for transmitting first configuration information that defines a first schedule of occasions for reception of a low power wakeup signal via a first radio of a wireless device associated with low power operation, means for transmitting second configuration information that defines a periodic C-DRX cycle that includes a second schedule of periodic ON durations to monitor a PDCCH via a second radio of the wireless device different than the first radio of the wireless device, and means for transmitting the low power wakeup signal via the first radio of the wireless device in accordance with the first configuration information and in advance of, by at least a threshold amount, a start of a next ON duration or a next PDCCH message.

A non-transitory computer-readable medium storing code for wireless communications is described. The code may include instructions executable by one or more processors to transmit first configuration information that defines a first schedule of occasions for reception of a low power wakeup signal via a first radio of a wireless device associated with low power operation, transmit second configuration information that defines a periodic C-DRX cycle that includes a second schedule of periodic ON durations to monitor a PDCCH via a second radio of the wireless device different than the first radio of the wireless device, and transmit the low power wakeup signal via the first radio of the wireless device in accordance with the first configuration information and in advance of, by at least a threshold amount, a start of a next ON duration or a next PDCCH message.

Some examples of the method, network entities, and non-transitory computer-readable medium described herein may further include operations, features, means, or instructions for transmitting the next PDCCH message during the next ON duration.

Some examples of the method, network entities, and non-transitory computer-readable medium described herein may further include operations, features, means, or instructions for transmitting the next PDCCH message during a subsequent ON duration that occurs after the next ON duration.

In some examples of the method, network entities, and non-transitory computer-readable medium described herein, the low power wakeup signal includes at least one bit that indicates whether to monitor the PDCCH during the next ON duration.

In some examples of the method, network entities, and non-transitory computer-readable medium described herein, transmitting the low power wakeup signal may include operations, features, means, or instructions for transmitting a TRS in accordance with third configuration information and in advance of the next ON duration.

In some examples of the method, network entities, and non-transitory computer-readable medium described herein, the third configuration information includes a TRS configuration and the third configuration information may be indicated by the low power wakeup signal.

Some examples of the method, network entities, and non-transitory computer-readable medium described herein may further include operations, features, means, or instructions for receiving a CSI report during the next ON duration and irrespective of a timer for C-DRX.

Some examples of the method, network entities, and non-transitory computer-readable medium described herein may further include operations, features, means, or instructions for transmitting control signaling to terminate monitoring the PDCCH, where the control signaling includes DCI.

In some examples of the method, network entities, and non-transitory computer-readable medium described herein, the low power wakeup signal includes a ON-OFF keying (OOK) waveform.

### BRIEF DESCRIPTION OF THE DRAWINGS

FIG. 1 shows an example of a wireless communications system that supports low power wakeup signaling in accordance with one or more aspects of the present disclosure.

FIG. 2 shows an example of a network architecture that supports low power wakeup signaling in accordance with one or more aspects of the present disclosure.

FIG. 3 shows an example of a wireless communications system that supports low power wakeup signaling in accordance with one or more aspects of the present disclosure.

FIGS. 4 through 6 show examples of signaling timelines that supports low power wakeup signaling in accordance with one or more aspects of the present disclosure.

FIG. 7 shows an example of a process flow that supports low power wakeup signaling in accordance with one or more aspects of the present disclosure.

FIGS. 8 and 9 show block diagrams of devices that support low power wakeup signaling in accordance with one or more aspects of the present disclosure.

FIG. 10 shows a block diagram of a communications manager that supports low power wakeup signaling in accordance with one or more aspects of the present disclosure.

FIG. 11 shows a diagram of a system including a device that supports low power wakeup signaling in accordance with one or more aspects of the present disclosure.

FIGS. 12 and 13 show block diagrams of devices that support low power wakeup signaling in accordance with one or more aspects of the present disclosure.

FIG. 14 shows a block diagram of a communications manager that supports low power wakeup signaling in accordance with one or more aspects of the present disclosure.

FIG. 15 shows a diagram of a system including a device that supports low power wakeup signaling in accordance with one or more aspects of the present disclosure.

FIGS. 16 and 17 show flowcharts illustrating methods that support low power wakeup signaling in accordance with one or more aspects of the present disclosure.

### DETAILED DESCRIPTION

A wireless device may be equipped with multiple radios, such as a primary radio and a secondary radio to support various operations (e.g., receiving, obtaining, monitoring, outputting, transmitting). In some examples, the primary radio and the secondary radio may be capable of, configured to, or operable to support low power operations as described herein. In some examples, the primary radio and the secondary radio may have the capability to support low power operations as described herein. In some other examples, the primary radio of the wireless device may be referred to as a main radio, while the secondary radio may be referred to as a low power radio. As such the secondary radio may be exclusively capable of, configured to, or operable to support low power operations as described herein. The secondary radio may may have the capability to support low power operations as described herein. A low power radio may include a transceiver (e.g., one or more receivers and/or transmitters) capable of, configured to, or operable to support lower power levels as compared to standard radios. For example, a low power radio may include a transceiver having the capability to support lower power levels (e.g., receive low power wake-up signals and efficiently toggle between on/off states) than those supported by main or primary radios in a user equipment (UE). The low power radio may be capable of, configured to, or operable to support energy efficiency, making the low power radio suitable for applications where power conservation may be achieved. The low power radio may be capable of, configured to, or operable to process less complex signals (e.g., signals with simpler waveforms, such as OOK, etc.) to reduce energy consumption compared to other complex signals (e.g., signals with more complex waveforms, such as FSK, OFDM).

The wireless device may be capable of, configured to, or operable to support low power operation (also referred to as discontinuous reception (DRX) operation, or connected-DRX (C-DRX) operation). DRX is a power-saving mechanism utilized by the wireless device to periodically switch between active and sleep states. During the sleep state, the wireless device temporarily disables its receiver to conserve power, periodically waking up to check for incoming data. This intermittent reception pattern helps extend the wireless device's battery life while maintaining connectivity to the network. C-DRX is another power-saving mechanism that allows the wireless device to synchronize its sleep cycles with the network's scheduling, enabling more efficient power management. C-DRX enables the wireless device to enter longer sleep periods during times of low data activity, reducing power consumption without sacrificing responsiveness to incoming data. This improved power-saving mechanism is important for prolonging battery life in battery-operated wireless devices and ensuring efficient utilization of network resource. The wireless device may support various operations (e.g., receiving, obtaining, monitoring, outputting, transmitting) during low power operation. By way of example, the wireless device may support various operations (e.g., receiving, obtaining, monitoring, outputting, transmitting) during a low power cycle (e.g., a C-DRX cycle). A low power cycle, such as a C-DRX cycle may be defined by one or more OFF durations (also referred to as inactive durations) and at least one ON duration (also referred to as an active duration).

In some cases, the primary radio of the wireless device may be configured for monitoring and receiving one or more wakeup signals before an ON duration. A wakeup signal is a signal transmitted by the network to the wireless device to prompt (e.g., trigger) the wireless device to exit a low-power state (e.g., a deep sleep mode) and become active. An example of a wake up signal may be a downlink control information (DCI) for power saving (DCP). Additionally, the primary radio of the wireless device may be configured for monitoring a control channel (e.g., a physical downlink control channel (PDCCH)) during the ON duration. That is, the wireless device may be capable of, configured to, or operable to receive a wakeup signal via the primary radio of the wireless device, triggering the wireless device to monitor a control channel (e.g., a PDCCH), for example, for downlink signaling (e.g., control information). The ON duration may be followed by an OFF duration, in which the wireless device stops monitoring the control channel (e.g., the PDCCH). In some cases, the wireless device may transition the primary radio to a deep sleep mode to conserve power when outside the ON duration (e.g., an OFF duration). In some cases, even during the deep sleep mode, the primary radio may still consume power. This occurs because the wireless device may need to periodically receive synchronization signals from the network to maintain synchronization (e.g., time and/or frequency synchronization) with the network, and the act of switching OFF and ON the primary radio may consume significant power. Switching ON and OFF a radio, such as the primary radio may involve activating or deactivating transmitter and/or receiver components (e.g., circuitry) within a wireless device. Therefore, in some cases, it might be preferable to keep the primary radio of the wireless device ON even during the deep sleep mode.

To achieve greater power savings at the wireless device, the secondary radio of the wireless device may operate at a lower power level compared to the primary radio of the wireless device. For instance, the secondary radio may be configured to receive and process signals with less complexity (e.g., signals with simpler waveforms, etc.) compared to the primary radio. Additionally, the secondary radio may be configured to support efficient power toggling (e.g., switching OFF and ON), enabling it to switch ON and OFF more effectively. The wireless device may monitor via the secondary radio for one or more low power wakeup signals during one or more scheduled occasions (e.g., time periods, slots, or other time units), and the wireless device may thereby fully power down the primary radio during periods outside of one or more scheduled ON durations. A low power wake up signal may refer to a specific type of signal that triggers the wireless device to power ON the primary radio, and the signal may be configured to consume minimal power, allowing the wireless device to conserve energy. Fully powering down the primary radio may include deactivating or shutting OFF all radio frequency transmission and reception capabilities of the primary radio. In some cases, the deep sleep mode may be referred to as the state where the primary radio is fully powered down and may include deactivating or shutting OFF all radio frequency transmission and reception capabilities of the primary radio. As such, the wireless device may be unable to transmit or receive any signals via the primary radio, thereby consuming minimal to no power. This effectively disables the primary radio from communicating with other wireless devices or networks until it is powered back ON. The wireless device may power up the primary radio if, for instance, the wireless device receives a low power wakeup signal via the secondary radio (e.g., low power radio) during at least one of the one or more scheduled occasions, indicating that the wireless device should monitor for a control channel (e.g., a PDCCH) during at least one of the one or more scheduled ON durations via the primary radio. By monitoring for and receiving the low power wake up signal via the secondary radio, the wireless device is consuming minimal power, and the wireless device may then power ON the primary radio to monitor the control channel (e.g., the PDCCH) and receive downlink signaling (e.g., control information) from the network.

Some wireless communication systems may support both the C-DRX cycle and the low power wake up signal. For example, a UE may be configured, by a network entity, with one or more OFF and one or more ON durations of a C-DRX cycle. The primary radio of the UE may be configured for monitoring and receiving one or more wakeup signals, such as DCP, via the primary radio before an ON duration. The UE may receive the DCP via the primary radio triggering the UE to monitor PDCCH for DCI. In addition, and in some cases, the UE may also be configured to monitor via the secondary radio for one or more low power wakeup signals during one or more scheduled occasions. The low power wake up signal may trigger the UE to power ON the primary radio. Efficient power toggling may involve dynamically switching between an inactive mode (e.g., OFF) and an active mode (e.g., ON) to conserve energy based on real-time needs and traffic patterns. In the case of C-DRX with low power wake up signal, the network entity transmits both low power wake up signal and the DCP to trigger the UE to monitor PDCCH. Reducing the amount of signaling to trigger the UE to monitor PDCCH may improve the C-DRX with the low power wake-up signal.

Techniques for triggering PDCCH monitoring by the low power wake up signal with the C-DRX configuration may reduce signaling between the UE and the network entity. For example, the DCP may be replaced by the low power wake up signal to trigger the UE to monitor PDCCH. Additionally or alternatively, the low power wake up signal may be received with sufficient time to allow the primary radio to be powered ON before monitoring PDCCH. In some examples, the UE may receive configuration information that schedules occasions for reception of a low power wakeup signal via a first radio of the UE (e.g., the low power wake up signal radio). The UE may receive configuration information that defines a periodic C-DRX cycle that includes scheduled periodic ON durations to monitor a PDCCH via a second radio of the UE (e.g., the main or primary radio of the UE). The UE may receive the low power wakeup signal in advance of, by at least a threshold amount, a start of a next ON duration or a next PDCCH message.

Aspects of the disclosure are initially described in the context of wireless communications systems. Aspects of the disclosure are further illustrated by and described with reference to apparatus diagrams, system diagrams, and flowcharts that relate to low power wakeup signaling.

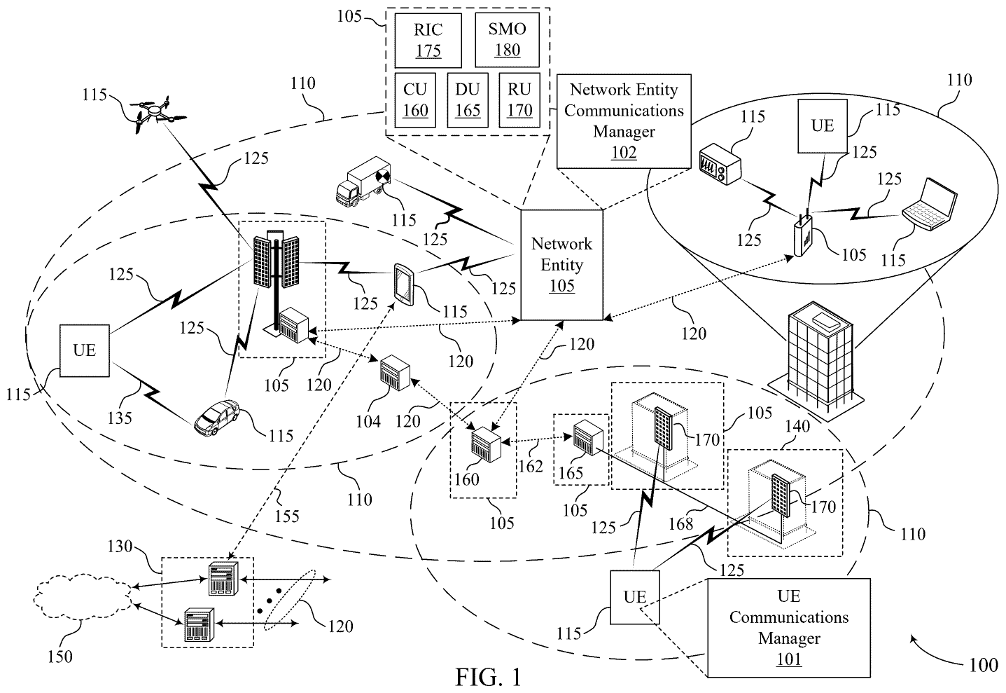

FIG. 1 shows an example of a wireless communications system 100 that supports low power wakeup signaling in accordance with one or more aspects of the present disclosure. The wireless communications system 100 may include one or more devices, such as one or more network devices (e.g., network entities 105), one or more UEs 115, and a core network 130. In some examples, the wireless communications system 100 may be an LTE network, an LTE-A network, an LTE-A Pro network, an NR network, or a network operating in accordance with other systems and radio technologies, including future systems and radio technologies not explicitly mentioned herein. The network entities 105 may include a network entity communications manager 102, which may be configured to support communications in the wireless communications system 100. Similarly, the UEs 115 may include a UE communications manager 101, which may be configured to support communications in the wireless communications system 100.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

As described herein, a node, which may be referred to as a node, a network node, a network entity, or a wireless node, may be a base station (e.g., any base station described herein), a UE (e.g., any UE described herein), a network controller, an apparatus, a device, a computing system, one or more components, and/or another suitable processing entity configured to perform any of the techniques described herein. For example, a network node may be a UE. As another example, a network node may be a base station. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE being configured to receive information from a base station also discloses that a first network node being configured to receive information from a second network node, the first network node may refer to a first UE, a first base station, a first apparatus, a first device, a first computing system, a first one or more components, a first processing entity, or the like configured to receive the information; and the second network node may refer to a second UE, a second base station, a second apparatus, a second device, a second computing system, a second one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δƒ) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δƒₘₐₓ·N_{ƒ}) seconds, for which Δƒₘₐₓ may represent a supported subcarrier spacing, and N_{ƒ} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{ƒ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A UE 115 may support various functionalities, including wireless communication (e.g., downlink reception, uplink transmission) in accordance with one or more modes of operation, including an idle mode, an inactive mode, and a connected mode. In the idle mode, the UE 115 might not be connected to the network and thereby may be unable to perform wireless communication (e.g., downlink reception, uplink transmission) with the network. However, the UE 115 may listen to a control channel (e.g., a physical downlink control channel (PDCCH)) to maintain synchronization with the network. In the inactive mode, the UE 115 may have established a connection with the network, but might not be performing wireless communication (e.g., downlink reception, uplink transmission) with the network. The inactive mode allows the UE 115 to reestablish (e.g., reactivate) the connection when wireless communication is required. In the connected mode, the UE 115 has an active connection with the network and is performing wireless communication (e.g., downlink reception, uplink transmission) with the network.

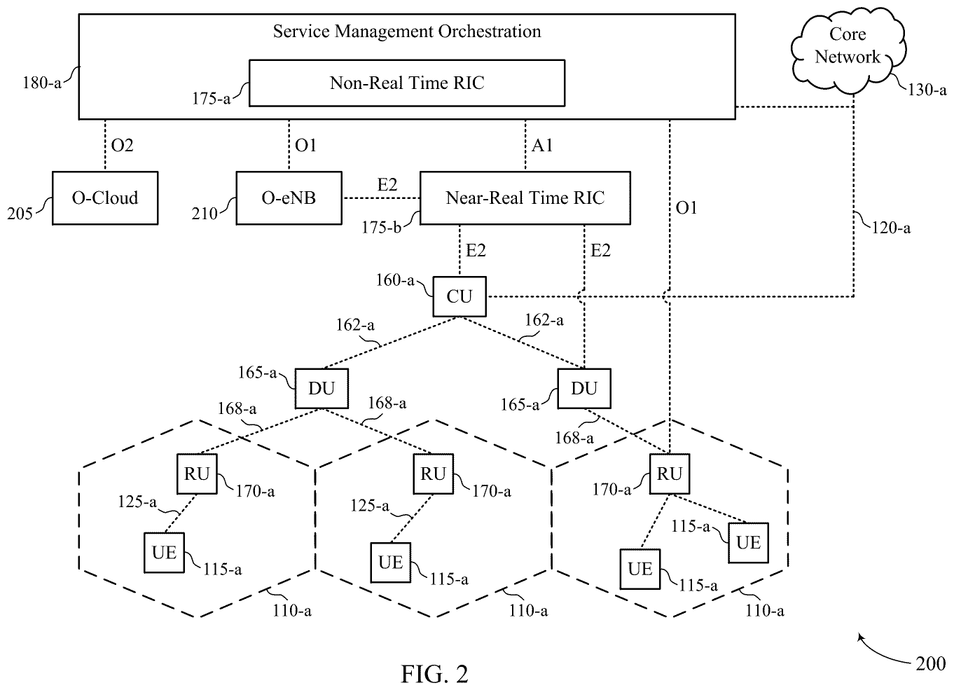

FIG. 2 shows an example of a network architecture 200 (e.g., a disaggregated base station architecture, a disaggregated RAN architecture) that supports low power wakeup signaling in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud- based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

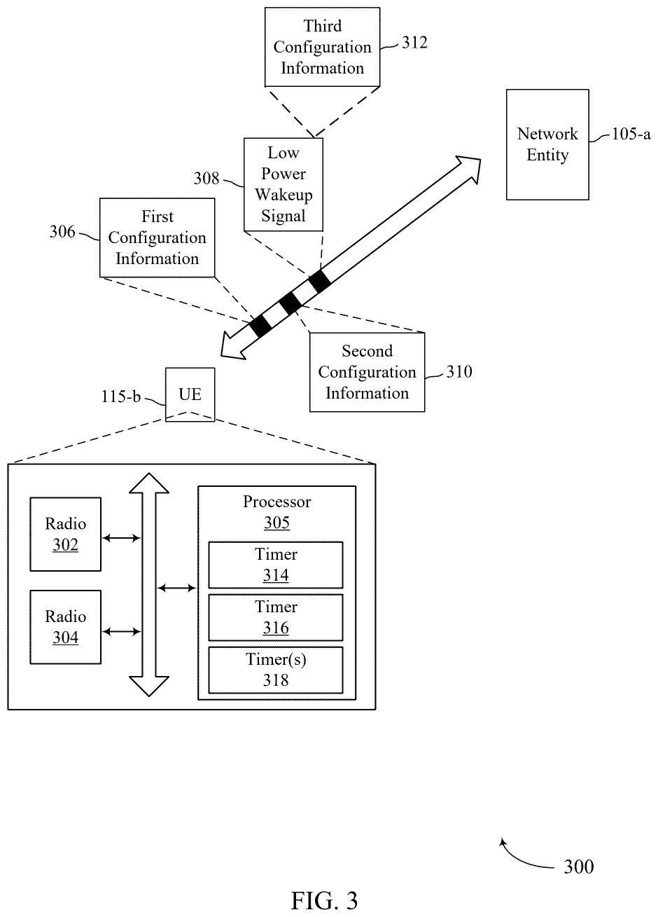

FIG. 3 shows an example of a wireless communications system 300 that supports low power wakeup signaling in accordance with one or more aspects of the present disclosure. The wireless communications system 300 may implement aspects of the wireless communications system 100 as described with reference to FIG. 1. The wireless communications system 300 may implement or be implemented by aspects of the network architecture 200 as described herein with reference to FIG. 2. For example, the wireless communications system 300 may include a network entity 105-a and a UE 115-b, which may be examples of network entities 105 and UEs 115 as described herein with reference to FIGS. 1 and 2, respectively. The wireless communications system 300 may support one or more radio access technologies including 4G, 5G, or radio access technologies beyond 5G. As such, one or more of the network entity 105-a or the UE 115-b may support one or more radio access technologies including 4G, 5G, or radio access technologies beyond 5G.

In the example of FIG. 3, the UE 115-b may be equipped with multiple radios, such as a radio 302 and a radio 304 to support various operations (e.g., receiving, obtaining, monitoring, outputting, transmitting). The radio 302 of the UE 115-b may be referred to as a low power radio, while the radio 304 of the UE 115-b may be referred to as a main radio. The UE 115-b may be equipped with at least one processor 305 configured to perform one or more of the operations described herein. The at least one processor 305 may include multiple processors configured to perform one or more of the operations described herein. The UE 115-b may have the capacity to, be capable of, configured to, or operable to support low power operation (also referred to as DRX operation, C-DRX operation). The UE 115-b may support various operations (e.g., receiving, obtaining, monitoring, outputting, transmitting) during low power operation. By way of example, the UE 115-b may support various operations (e.g., receiving, obtaining, monitoring, outputting, transmitting) during a low power cycle (e.g., a C-DRX cycle). A low power cycle, such as a C-DRX cycle may be defined by one or more OFF durations (also referred to as inactive durations) and at least one ON duration (also referred to as an active duration). In some cases, the C-DRX cycle may include an offset (e.g., a timing offset) between a beginning of the C-DRX cycle and a beginning of the at least one ON duration. That is, the offset may define the start of the at least one ON duration relative to the start of the C-DRX cycle.

In some cases, the radio 304 of the UE 115-b may be configured for monitoring and receiving one or more wakeup signals before an ON duration. Additionally, the radio 304 of the UE 115-b may be configured for monitoring a control channel (e.g., a PDCCH) during the ON duration. That is, the UE 115-b may be capable of, configured to, or operable to receive a wakeup signal via the radio 304 of the UE 115-b during a C-DRX cycle, triggering the UE 115-b to monitor a control channel (e.g., a PDCCH), for example, for downlink signaling from the network entity 105-a. The ON duration may be followed by an OFF duration, in which the UE 115-b stops monitoring the control channel (e.g., the PDCCH).

In some cases, the UE 115-b may transition the radio 304 of the UE 115-b to a deep sleep mode to conserve power when outside the ON duration. In certain instances, even during deep sleep mode, the radio 304 of the UE 115-b may still consume power. This occurs because the UE 115-b may need to periodically receive synchronization signals from the network entity 105-a to maintain synchronization (e.g., time and/or frequency synchronization) with the network entity 105-a, and the act of switching OFF and ON the radio 304 of the UE 115-b may consume significant power. Therefore, in some cases, it might be preferable to keep the radio 304 of the UE 115-b ON even during deep sleep mode. In some cases, the deep sleep mode is a power-saving state where the radio 304 is inactive or turned off.

In some cases, the UE 115-b may start an inactivity timer if the UE 115-b receives downlink signaling and may switch the radio 304 of the UE 115-b to a lower power mode (e.g., deep sleep mode) when the inactivity timer expires. In some cases, the UE 115-b may receive one or more synchronization signals (e.g., one or more synchronization signal blocks (SSBs)) via the radio 304 of the UE 115-b. The UE 115-b may have to receive the one or more synchronization signals to maintain synchronization with the network entity 105-a. Additionally, or alternatively, the UE 115-b may support CSI reporting via the radio 304 of the UE 115-b during an ON duration.

To achieve greater power savings at the UE 115-b, the radio 302 of the UE 115-b may operate at a lower power level compared to the radio 304 of the UE 115-b. For instance, the radio 302 of the UE 115-b may be configured to receive and process signals with less complexity (e.g., signals with simpler waveforms, such as OOK waveforms, etc.) compared to the radio 304 of the UE 115-b. Additionally, the radio 302 of the UE 115-b may be designed to support efficient power toggling, enabling it to switch ON and OFF more effectively. In some cases, efficient power toggling may involve dynamically switching between an inactive mode (e.g., OFF) and an active mode (e.g., ON) to conserve energy based on real-time needs and traffic patterns. The UE 115-b may monitor for one or more low power wakeup signals during one or more scheduled occasions, and the UE 115-b may thereby fully power down the radio 304 during periods outside of one or more scheduled ON durations. The UE 115-b may power up the radio 304 if, for instance, the UE 115-b receives a low power wakeup signal during at least one of the one or more scheduled occasions, indicating that the UE 115-b should monitor for a control channel (e.g., a PDCCH) during at least one of the one or more scheduled ON durations via the radio 304 of the UE 115-b.

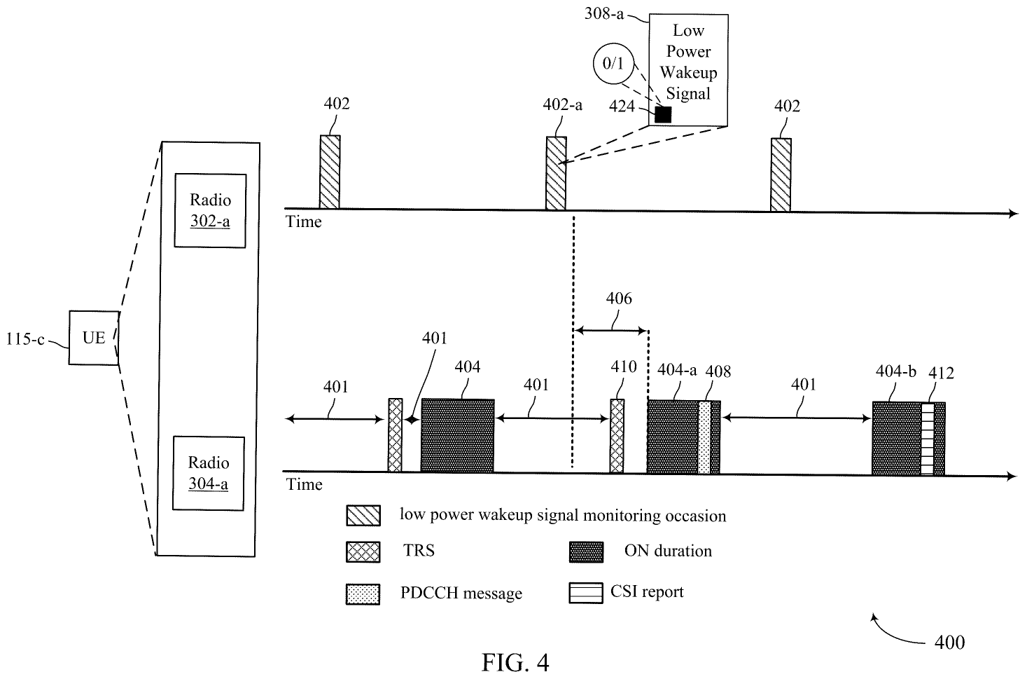

The UE 115-b may receive first configuration information 306 that defines a first schedule of occasions for reception of a low power wakeup signal 308 via the radio 302 of the UE 115-b associated with low power operation. The low power wakeup signal 308 may have or be an ON-OFF keying (OOK) waveform. The UE 115-b may receive second configuration information 310 that defines a periodic C-DRX cycle that includes a second schedule of periodic ON durations to monitor a PDCCH via the radio 304 of the UE 115-b. Periodic ON durations may occur at regular intervals (e.g., every x millisecond, second, slot, or other time unit). The UE 115-b may receive the low power wakeup signal 308 via the radio 302 of the UE 115-b in accordance with the first configuration information 306 and in advance of, by at least a threshold amount, a start of a next ON duration or a next PDCCH message as described in more detail with reference to FIGS. 4 through 6.

The UE 115-b may monitor the PDCCH via the radio 304 of the UE 115-b during the next ON duration based on receiving the low power wakeup signal 308 via the radio 302 of the UE 115-b and in advance of, by at least the threshold amount, the start of the next ON duration or the next PDCCH message. The UE 115-b may receive the next PDCCH message via the radio 304 of the UE 115-b during the next ON duration based on the monitoring. In some examples, the UE 115-b may monitor the PDCCH via the radio 304 of the UE 115-b after the next ON duration based on receiving the low power wakeup signal 308 via the radio 302 of the UE 115-b within at least the threshold amount of the start of the next ON duration. The UE 115-b may receive the next PDCCH message via the radio 304 of the UE 115-b during a subsequent ON duration that occurs after the next ON duration as described in more detail with reference to FIGS. 4 through 6.

In some examples, the UE 115-b may monitor the PDCCH via the radio 304 of the UE 115-b during the next ON duration based on at least one bit included in the received low power wakeup signal 308 as described in more detail with reference to FIG. 4. The UE 115-b may refrain (e.g., inhibit, prevent, stop, block, avoid, skip) from monitoring the PDCCH via the radio 304 of the UE 115-b during the next ON duration based on the at least one bit included in the received low power wakeup signal 308. In some examples, the UE 115-b may monitor the PDCCH via the radio 304 of the UE 115-b during the next ON duration irrespective (e.g., regardless of, independent of) of at least one bit included in the received low power wakeup signal 308. Additionally or alternatively, the UE 115-b may receive the low power wakeup signal 308 via the radio 302 of the UE 115-b in advance of, by at least the threshold amount, the next ON duration, and receive a TRS via the radio 304 of the UE 115-b in accordance with third configuration information 312 and in advance of the next ON duration. The third configuration information 312 includes a TRS configuration, and the third configuration information 312 may be indicated by the low power wakeup signal 308.

The UE 115-b may receive the low power wakeup signal 308 via the radio 302 of the UE 115-b in advance of the next ON duration, and monitor the PDCCH via the radio 304 of the UE 115-b for the next PDCCH message based on receiving the low power wakeup signal 308 via the radio 302 of the UE 115-b and in advance of the next PDCCH message. The UE 115-b may terminate (e.g., stop, end) monitoring the PDCCH via the radio 304 of the UE 115-b for the next PDCCH message based at least in part on an expiration of one or more of an inactivity timer 314, an expiration of an ON duration timer 316 for connected-mode discontinuous reception, or an expiration of one or more timers 318 associated with the low power wakeup signal 308 as described in more detail with reference to FIGS. 4 through 6.

Accordingly, to experience power efficiency at the UE 115-b, the radio 302 may be set to operate at a reduced power level compared to the radio 304 of the UE 115-b. Specifically, the radio 302 may process signals with simpler characteristics, such as signals with less complex waveforms (e.g., OOK waveform). An OOK waveform may be a form of amplitude modulation where a carrier signal is turned ON and OFF to represent a binary pattern (e.g., binary data). Moreover, the radio 302 of the UE 115-b may be configured to facilitate seamless power toggling, allowing for more efficient activation and deactivation processes compared to the radio 304 of the UE 115-b. In some cases, seamless power toggling may involve dynamically switching between an inactive mode (e.g., OFF) and an active mode (e.g., ON) in an efficient and timely manner. As a result, the UE 115-b may actively monitor for one or more wakeup signals during scheduled occasions while fully deactivating the radio 304 of the UE 115-b during periods outside the scheduled ON durations.

FIG. 4 shows an example of a signaling timeline 400 that supports low power wakeup signaling in accordance with one or more aspects of the present disclosure. The signaling timeline 400 may implement aspects of the wireless communications system 100 as described with reference to FIG. 1. The signaling timeline 400 may implement or be implemented by aspects of the network architecture 200 as described herein with reference to FIG. 2. The signaling timeline 400 may implement or be implemented by aspects of the wireless communications system 300 as described with reference to FIG. 3. The signaling timeline 400 may implement or be implemented by 5G or radio access technologies beyond 5G.

For example, a UE 115-c may execute a set of instructions to control the functional elements (e.g., circuitry) of the UE 115-c to perform the described functions. The UE 115-c may be examples of UEs as described with reference to FIGS. 1 through 3. Additionally, or alternatively, the UE 115-c may perform aspects of the described functions using a radio 302-a or a radio 304-a, which may be examples of a radio 302 and a radio 304 as described with reference to FIG. 3.

In the following description of the signaling timeline 400, the operations performed by the UE 115-c may be in a different order than the example order shown, or the operations performed by the UE 115-c may be performed in different orders or at different times. Some operations may also be omitted from the signaling timeline 400, and other operations may be added to the signaling timeline 400.

The UE 115-c may be equipped with multiple radios, such as the radio 302-a and the radio 304-a to support various operations (e.g., receiving, obtaining, monitoring, outputting, transmitting). In the example of FIG. 4, the radio 302-a of the UE 115-c may be referred to as a low power radio, while the radio 304-a of the UE 115-c may be referred to as a main radio. The radio 302-a of the UE 115-c may be configured for monitoring and receiving one or more low power wakeup signals during one or more scheduled occasions 402 (also referred to as low power wakeup signal monitoring occasions). The radio 304-a of the UE 115-c may be configured for monitoring and receiving one or more control channels (e.g., one or more PDCCH) during one or more scheduled ON durations 404 (also referred to as active durations) of a C-DRX cycle. A C-DRX cycle consists of two components: an ON duration 404 and an OFF duration (i.e., period outside of the ON duration 404).

The UE 115-c may transition the radio 304-a of the UE 115-c to a deep sleep mode to conserve power when outside the one or more scheduled ON durations 404. Consequently, the UE 115-c may refrain (e.g., inhibit, prevent, stop, block, avoid, skip) from monitoring one or more control channels (e.g., one or more PDCCH) outside the one or more scheduled ON durations 404. In certain instances, even during deep sleep mode, the radio 304-a of the UE 115-c may still consume power. This occurs because the UE 115-c may need to periodically receive synchronization signals from the network to maintain synchronization (e.g., time and/or frequency synchronization) with the network, and the act of switching OFF and ON the radio 304-a of the UE 115-c may consume significant power. Therefore, it is preferable to keep the radio 304-a of the UE 115-c ON even during deep sleep mode.

To achieve greater power savings at the UE 115-c, the radio 302-a of the UE 115-c may operate at a lower power level compared to the radio 304-a of the UE 115-c. For instance, the radio 302-a of the UE 115-c may be configured to receive and process signals with less complexity (e.g., signals with simpler waveforms, such as OOK waveform) compared to the radio 304-a of the UE 115-c. Additionally, the radio 302-a of the UE 115-c may be designed to support efficient power toggling (e.g., switching the radio 302-a of the UE 115-c ON or OFF), enabling it to switch ON and OFF more effectively. Consequently, the UE 115-c may monitor for one or more wakeup signals during the one or more scheduled occasions 402, and the UE 115-c may power down the radio 304-a during periods 401 outside of the one or more scheduled ON durations 404. The UE 115-c may power up the radio 304-a if, for instance, the UE 115-c receives a low power wakeup signal during at least one of the one or more scheduled occasions 402, indicating that the UE 115-c should monitor for a control channel (e.g., a PDCCH) during at least one of the one or more scheduled ON durations 404 via the radio 304-a of the UE 115-c. Additionally or alternatively, the UE 115-c may power down (e.g., turn OFF circuitry, such a receiver and transmitter of) the radio 302-a if the UE 115-c does not anticipate receiving low power wakeup signals or other low power signals (e.g., low power reference signals, low power synchronization signals).

In the example of FIG. 4, the one or more scheduled occasions 402 may be configured to occur in advance of the start of the one or more scheduled ON durations 404 by at least a threshold amount 406. That is, a scheduled occasion 402-a may be configured to occur before the start of a next ON duration 404-a following the scheduled occasion 402-a by at least a threshold time. The threshold time may represent the minimum duration required for the UE 115-c to power ON the radio 304-a. If the UE 115-c receives a low power wakeup signal 308-a via the radio 302-a of the UE 115-c during the scheduled occasion 402-a, where the scheduled occasion 402-a occurs before the start of the next ON duration 404-a or a next PDCCH message 408 by at least the threshold amount 406, the UE 115-c may monitor a control channel (e.g., PDCCH) during the next ON duration 404-a via the radio 304-a of the UE 115-c. That is, if the UE 115-c receives the low power wakeup signal 308-a during the scheduled occasion 402-a, the UE 115-c may start (e.g., begin, commence, trigger, enable) a timer, such as an onDurationTimer associated with the next ON duration 404-a. For instance, the UE 115-c may power ON the radio 304-a to monitor the control channel (e.g., PDCCH) during the next ON duration 404-a and receive the next PDCCH message 408 based on this monitoring. However, if the scheduled occasion 402-a does not occur before the start of the next ON duration 404-a by at least the threshold amount 406, the UE 115-c may be configured to monitor a control channel (e.g., PDCCH) during a subsequent ON duration 404-b, for example, after the next ON duration 404-a.

In some examples, the low power wakeup signal 308-a may include at least one bit 424 that indicates whether to monitor the control channel (e.g., PDCCH) during the next ON duration 404-a. This means that the low power wakeup signal 308-a may explicitly instruct the UE 115-c whether to monitor or not monitor the control channel (e.g., PDCCH) during the next ON duration 404-a. In some cases, if the UE 115-c monitors for the low power wakeup signal 308-a via the radio 302-a of the UE 115-c during the scheduled occasion 402-a and does not receive it, the UE 115-c may, by default, monitor the control channel (e.g., PDCCH) via the radio 304-a of the UE 115-c during the next ON duration 404-a. This means that the UE 115-c may monitor the control channel (e.g., PDCCH) using the radio 304-a during the next ON duration 404-a regardless of (e.g., irrespective of) the presence of the at least one bit 424 included in the low power wakeup signal 308-a.

In some other examples, the low power wakeup signal 308-a may exclude (e.g., not include) the at least one bit 424 that indicates whether to monitor the control channel (e.g., PDCCH) during the next ON duration 404-a. In this example, if the UE 115-c monitors via the radio 302-a of the UE 115-c for the low power wakeup signal 308-a during the scheduled occasion 402-a and receives the low power wakeup signal 308-a during the scheduled occasion 402-a, the UE 115-c may monitor the control channel (e.g., PDCCH) during the next ON duration 404-a. Otherwise, if the UE 115-c monitors via the radio 302-a of the UE 115-c for the low power wakeup signal 308-a during the scheduled occasion 402-a and does not receive the low power wakeup signal 308-a during the scheduled occasion 402-a, the UE 115-c may, for example, as a default, refrain (e.g., inhibit, prevent, stop, block, avoid, skip) from monitoring the control channel (e.g., PDCCH) during the next ON duration 404-a.

In the example of FIG. 4, after receiving the low power wakeup signal 308-a during the scheduled occasion 402-a via the radio 302-a of the UE 115-c, and before monitoring the control channel (e.g., PDCCH) during the next ON duration 404-a, the UE 115-c may receive a TRS 410 via the radio 304-a of the UE 115-c. Alternatively, the UE 115-c may receive the TRS 410 during the next ON duration 404-a via the radio 304-a of the UE 115-c. The TRS 410, received from a network entity 105 or a base station 140 as described herein with reference to FIGS. 1 through 3, may be received in advance of the next ON duration 404-a. In some examples, the TRS 410 may indicate a TRS configuration, as indicated by the low power wakeup signal 308-a. This TRS configuration may enable the UE 115-c to synchronize with the network entity 105 or the base station 140 as described herein with reference to FIGS. 1 through 3. In some examples, the UE 115-c may have to receive the TRS 410 before monitoring the control channel (e.g., PDCCH) during the next ON duration 404-a because synchronization, such as frequency and time synchronization, may be performed via the radio 304-a of the UE 115-c. Additionally, synchronization with the network entity 105 or the base station 140, as described herein with reference to FIGS. 1 through 3, may be necessary before the UE 115-c is capable of monitoring the control channel (e.g., PDCCH).

The UE 115-c may support CSI measurement and reporting during at least one of the one or more ON durations 404. For example, the UE 115-c may receive and measure one or more CSI-RS via the radio 304-a of the UE 115-c. Subsequently, the UE 115-b may transmit a CSI report based on the measured one or more CSI-RS via the radio 304-a of the UE 115-c. For instance, during an ON duration 404, such as the ON duration 404-b, the UE 115-c may transmit a CSI report 412 based on received CSI-RS. The CSI report 412 may provide CSI to the network entity 105 or the base station 140, as described herein with reference to FIGS. 1 through 3. The CSI may indicate channel quality, channel gains, and other CSI parameters. In the example of FIG. 4, the UE 115-c may be configured to transmit the CSI report 412 irrespective of a timer for C-DRX. That is, the UE 115-c may be configured to transmit the CSI report 412 even when a timer, such as an onDurationTimer, has not been triggered by a low power wakeup signal, such as the low power wakeup signal 308-a. Alternatively, the UE 115-c may be configured to refrain from transmitting (e.g., skip transmitting) the CSI report 412 when a timer, such as onDurationTimer, has not been triggered by a low power wakeup signal, such as the low power wakeup signal 308-a. The CSI report 412 may include (e.g., contain, indicate, identify) one or more layer 1 (L1) reference signal received power (RSRP) (L1-RSRP) or L1 signal-to-interference-plus-noise ratio (L1-SINR) measurements. L1 measurements, such as L1-RSRP and/or L1-SINR may refer to measurements performed at a PHY layer of the UE 115-c.

Accordingly, to experience power efficiency at the UE 115-c, the radio 302-a may be set to operate at a reduced power level compared to the radio 304-a. Specifically, the configuration of the radio 302-a may prioritize the processing of signals with simpler characteristics, such as signals with less complex waveforms. Moreover, the radio 302-a may be configured to facilitate seamless power toggling, allowing for more efficient activation and deactivation processes. As a result, the UE 115-c may actively monitor for one or more wakeup signals during scheduled occasions 402 while deactivating the radio 304-a during periods outside the scheduled ON durations 404. Upon receiving a low power wakeup signal during the scheduled occasions 402 as described herein, indicating the need to monitor a control channel (e.g., a PDCCH) during the subsequent scheduled ON durations 404, the UE 115-c may activate the radio 304-a accordingly.

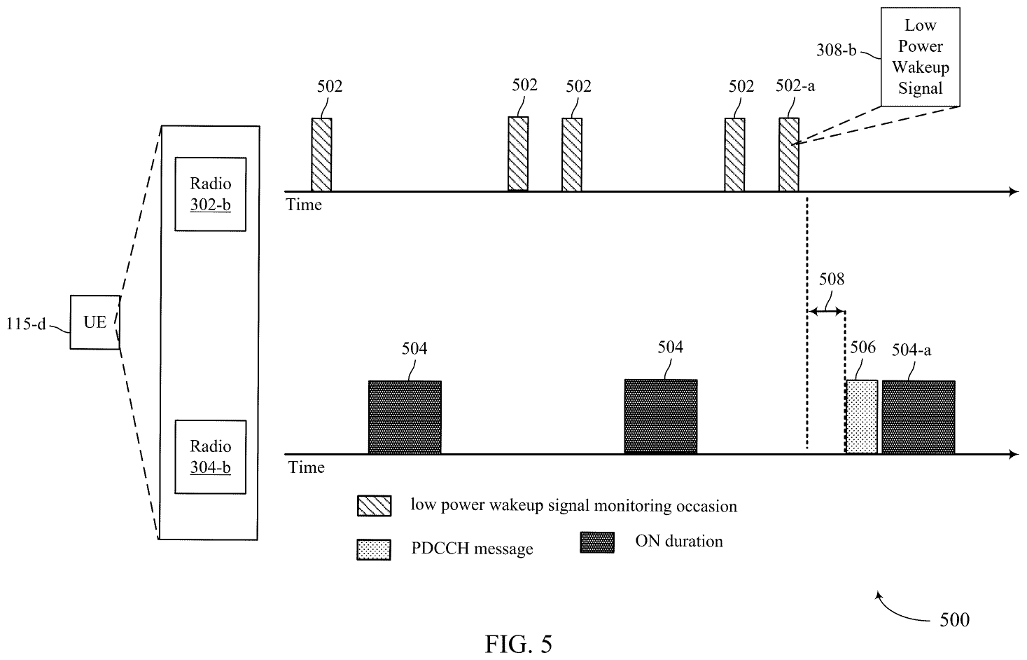

FIG. 5 shows an example of a signaling timeline 500 that supports low power wakeup signaling in accordance with one or more aspects of the present disclosure. The signaling timeline 500 may implement aspects of the wireless communications system 100 as described with reference to FIG. 1. The signaling timeline 500 may implement or be implemented by aspects of the network architecture 200 as described herein with reference to FIG. 2. The signaling timeline 500 may implement or be implemented by aspects of the wireless communications system 300 as described with reference to FIG. 3. The signaling timeline 500 may implement or be implemented by 5G or radio access technologies beyond 5G.

For example, a UE 115-d may execute a set of instructions to control the functional elements (e.g., circuitry) of the UE 115-d to perform the described functions. The UE 115-d may be examples of UEs as described with reference to FIGS. 1 through 3. Additionally, or alternatively, the UE 115-d may perform aspects of the described functions using a radio 302-b or a radio 304-b, which may be examples of a radio 302 and a radio 304 as described with reference to FIG. 3.

In the following description of the signaling timeline 500, the operations performed by the UE 115-d may be in a different order than the example order shown, or the operations performed by the UE 115-d may be performed in different orders or at different times. Some operations may also be omitted from the signaling timeline 500, and other operations may be added to the signaling timeline 500.

The UE 115-d may be equipped with multiple radios, such as the radio 302-b and the radio 304-b to support various operations (e.g., receiving, obtaining, monitoring, outputting, transmitting). In the example of FIG. 5, the radio 302-b of the UE 115-d may be referred to as a low power radio, while the radio 304-b of the UE 115-d may be referred to as a main radio. The radio 302-b of the UE 115-d may be configured for monitoring and receiving one or more low power wakeup signals during one or more scheduled occasions 502 (also referred to as low power wakeup signal monitoring occasions). The radio 304-b of the UE 115-d may be configured for monitoring and receiving one or more control channels (e.g., one or more PDCCH) during one or more scheduled ON durations 504 (also referred to as active durations) of a C-DRX cycle.

To achieve greater power savings at the UE 115-d, the radio 302-b of the UE 115-d may operate at a lower power level compared to the radio 304-b of the UE 115-d. For instance, the radio 302-b of the UE 115-d may be configured to receive and process signals with less complexity (e.g., signals with simpler waveforms, etc.) compared to the radio 304-b of the UE 115-d. Additionally, the radio 302-b of the UE 115-d may be designed to support efficient power toggling, enabling it to switch ON and OFF more effectively compared to the radio 304-b of the UE 115-d.

The UE 115-d may monitor for one or more wakeup signals during the scheduled occasions 502, and the UE 115-d may power down the radio 304-b outside of the scheduled ON durations 504. In some examples, the UE 115-d may monitor at least one scheduled occasion 502 of the one or more scheduled occasions 502 before a scheduled ON duration 504 of the one or more scheduled ON durations 504. That is, the UE 115-d may monitor one scheduled occasion 502 per scheduled ON duration 504. In some other examples, the UE 115-d may monitor multiple scheduled occasions (e.g., at least two scheduled occasions 502) before a scheduled ON duration 504. The UE 115-d may power up the radio 304-b if the UE 115-d receives a low power wakeup signal during any of the scheduled occasions 502, indicating that the UE 115-d should monitor for a control channel 506 (e.g., a PDCCH) after receiving the low power wakeup signal 308-b and before the next scheduled ON duration 504-a. In some examples, the monitoring of the control channel 506 (e.g., PDCCH monitoring) may be triggered by the low power wakeup signal 308-b in addition to the scheduled ON duration 504-a. The UE 115-d may power up the radio 304-b to monitor the control channel (e.g., a PDCCH) during the scheduled ON duration 504-a via the radio 304-b even if the UE 115-d does not receive low power wakeup signal, for example, in the scheduled occasion 502-a (e.g., a preceding scheduled occasion). That is, the UE 115-d may monitor each scheduled ON duration 504 irrespective (e.g., regardless of) whether the UE 115-d receives a low power wakeup signal. In some other examples, the monitoring of the control channel (e.g., PDCCH monitoring) may be triggered by the low power wakeup signal 308-b instead of the scheduled ON duration 504-a. The UE 115-d may refrain from monitoring a control channel (e.g., a PDCCH) during the scheduled ON duration 504-a if the UE 115-d receives the low power wakeup signal 308-b during the scheduled occasion 502-a prior to the schedule ON duration 504-a. That is, if the UE 115-d receives the low power wakeup signal 308-b, triggering the monitoring of the control channel 506 prior to the scheduled ON duration 504-a, the UE 115-d may skip (e.g., cancel) monitoring of control channels (e.g., PDCCH monitoring) during the upcoming scheduled ON duration 504-a.

In the example of FIG. 5, the UE 115-d may receive via the radio 302-b of the UE 115-d a low power wakeup signal 308-b during a scheduled occasion 502-a of the one or more scheduled occasions 502. In some examples, if the UE 115-d receives the low power wakeup signal 308-b during a scheduled occasion 502-a of the one or more scheduled occasions 502 and in advance of, by at least a threshold amount, a next ON duration, such as the ON duration 504-a, or PDCCH monitoring triggered by the low power wakeup signal 308-b, the UE 115-d may begin monitoring a control channel 506 (e.g., PDCCH) after a threshold amount 508 (e.g., threshold amount of time) after receiving the low power wakeup signal 308-b. That is, upon receiving a low power wakeup signal 308-b, the UE 115-d starts monitoring the control channel 506 (e.g., PDCCH) within a certain time period after receiving the low power wakeup signal.

The UE 115-d may be configured to support low power operation according to one or more timers. For example, the UE 115-d may be configured to support low power operation according to an ON duration timer (e.g., onDurationTimer), an inactivity timer (e.g., inactivityTimer), or one or more timers associated with the low power wakeup signal 308-b. The UE 115-b may be configured to, for example, terminate (e.g., stop, end, pause) monitoring the control channel 506 (e.g., PDCCH), triggered by the low power wakeup signal 308-b, in response to (e.g., based at least in part on) an expiration of the above example timers. The one or more timers associated with the low power wakeup signal 308-b may be separate timers associated with C-DRX, and control channel monitoring triggered by low power wakeup signal 308-b may terminate when one or more of these timers expire. Additionally, or alternatively, the UE 115-d may receive via the radio 304-a of the UE 115-d control signaling from a network entity 105 or a base station 140, as described herein with reference to FIGS. 1 through 3, to terminate (e.g., stop, end, pause) monitoring the control channel 506 (e.g., PDCCH), triggered by the low power wakeup signal 308-b. The control signaling may include a MAC control element (MAC-CE).

Accordingly, to experience power efficiency at the UE 115-d, the radio 302-b may be set to operate at a reduced power level compared to the radio 304-b. Additionally, the above-described functions of the UE 115-d may reduce latency when a length of a C-DRX cycle is relatively long. Put another way, the UE 115-d may avoid compromising latency for power saving, by configuring C-DRX for maximum power savings, and with multiple low power wakeup signals configured in between ON durations, latency can be reduced.

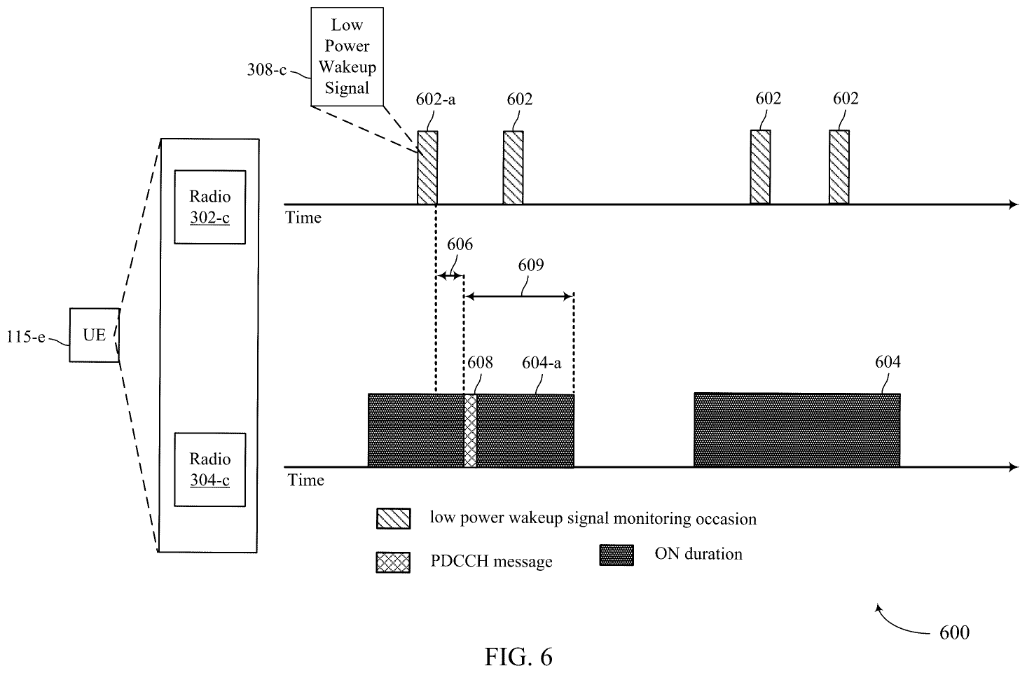

FIG. 6 shows an example of a signaling timeline 600 that supports low power wakeup signaling in accordance with one or more aspects of the present disclosure. The signaling timeline 600 may implement aspects of the wireless communications system 100 as described with reference to FIG. 1. The signaling timeline 600 may implement or be implemented by aspects of the network architecture 200 as described herein with reference to FIG. 2. The signaling timeline 600 may implement or be implemented by aspects of the wireless communications system 300 as described with reference to FIG. 3. The signaling timeline 600 may implement or be implemented by 5G or radio access technologies beyond 5G.

For example, a UE 115-e may execute a set of instructions to control the functional elements (e.g., circuitry) of the UE 115-e to perform the described functions. The UE 115-e may be examples of UEs as described with reference to FIGS. 1 through 3. Additionally, or alternatively, the UE 115-e may perform aspects of the described functions using a radio 302-c or a radio 304-c, which may be examples of a radio 302 and a radio 304 as described with reference to FIG. 3.

In the following description of the signaling timeline 600, the operations performed by the UE 115-e may be in a different order than the example order shown, or the operations performed by the UE 115-e may be performed in different orders or at different times. Some operations may also be omitted from the signaling timeline 600, and other operations may be added to the signaling timeline 600.

The UE 115-e may be equipped with multiple radios, such as the radio 302-c and the radio 304-c to support various operations (e.g., receiving, obtaining, monitoring, outputting, transmitting). In the example of FIG. 6, the radio 302-c of the UE 115-e may be referred to as a low power radio, while the radio 304-c of the UE 115-e may be referred to as a main radio. The radio 302-c of the UE 115-e may be configured for monitoring and receiving one or more low power wakeup signals during one or more scheduled occasions 602 (also referred to as low power wakeup signal monitoring occasions). The radio 304-c of the UE 115-e may be configured for monitoring and receiving one or more control channels (e.g., one or more PDCCH) during one or more scheduled ON durations 604 (also referred to as active durations) of a C-DRX cycle. To achieve greater power savings at the UE 115-e, the radio 302-c of the UE 115-e may operate at a lower power level compared to the radio 304-c of the UE 115-e as described herein.

In the example of FIG. 6, the UE 115-e may receive a low power wakeup signal 308-c via the radio 302-c of the UE 115-d during a scheduled occasion 602-a and in advance of, by at least a threshold amount, a next PDCCH message during a current ON duration 604-a. The UE 115-e may perform control channel monitoring 609 (e.g., PDCCH monitoring) via the radio 304-c of the UE 115-e during the current ON duration 604-a. The UE 115-e may begin the control channel monitoring 609 (e.g., PDCCH monitoring) during the current ON duration 604-a, after a threshold amount 606 (e.g., threshold amount of time) from receiving the low power wakeup signal 308-c. That is, upon receiving a low power wakeup signal 308-c, the UE 115-e may start the control channel monitoring 609 (e.g., PDCCH monitoring) within a certain time period after receiving the low power wakeup signal 308-c.

The UE 115-e may be configured to support low power operation according to one or more timers. The UE 115-e may enable one or more of an inactivity timer or an ON duration timer based on receiving the low power wakeup signal 308-c via the radio 302-c of the UE 115-e or based on receiving a PDCCH message 608. For example, the UE 115-e may start or restart an inactivity timer after receiving the low power wakeup signal 308-c via the radio 302-c of the UE 115-e, or the UE 115-e may start or restart an inactivity timer after receiving the PDCCH message 608 via the radio 302-c of the UE 115-e. In some examples, the UE 115-b may be configured to, for example, terminate the control channel monitoring 609 (e.g., PDCCH monitoring), triggered by the low power wakeup signal 308-c, in response to (e.g., based at least in part on) an expiration of the above example timers (e.g., one or more of the inactivity timer or the ON duration timer) associated with the current ON duration 604-a.

In some examples, the UE 115-e may receive via the radio 304-c of the UE 115-e for a TRS, as described with reference to FIG. 4, within a certain time period after receiving the low power wakeup signal 308-c, and prior to the control channel monitoring 609 (e.g., PDCCH monitoring), triggered by the low power wakeup signal 308-c, during the current ON duration 604-a. The TRS, received from a network entity 105 or a base station 140 as described herein with reference to FIGS. 1 through 4, may be received during the current ON duration 604-a. In some examples, the low power wakeup signal 308-c may indicate a TRS configuration. This TRS configuration may enable the UE 115-e to synchronize with the network entity 105 or the base station 140 as described herein with reference to FIGS. 1 through 4. The UE 115-e may have to receive the TRS before the control channel monitoring 609 (e.g., PDCCH monitoring) during the current ON duration 604-a because synchronization, such as frequency and time synchronization, may need to be performed via the radio 304-c of the UE 115-e. Additionally, synchronization with the network entity 105 or the base station 140, as described herein with reference to FIGS. 1 through 4, may be necessary before the UE 115-e is capable of performing the control channel monitoring 609 (e.g., PDCCH monitoring).

Accordingly, to experience power efficiency at the UE 115-e, the radio 302-c may be set to operate at a reduced power level compared to the radio 304-c. Additionally, the above-described functions of the UE 115-e may reduce power consumption and processing when a beginning of an ON duration has no data transmission for the UE 115-e. Put another way, the UE 115-e may save power in the beginning portion of an ON duration if there's no pending data transmission from the network for this portion.

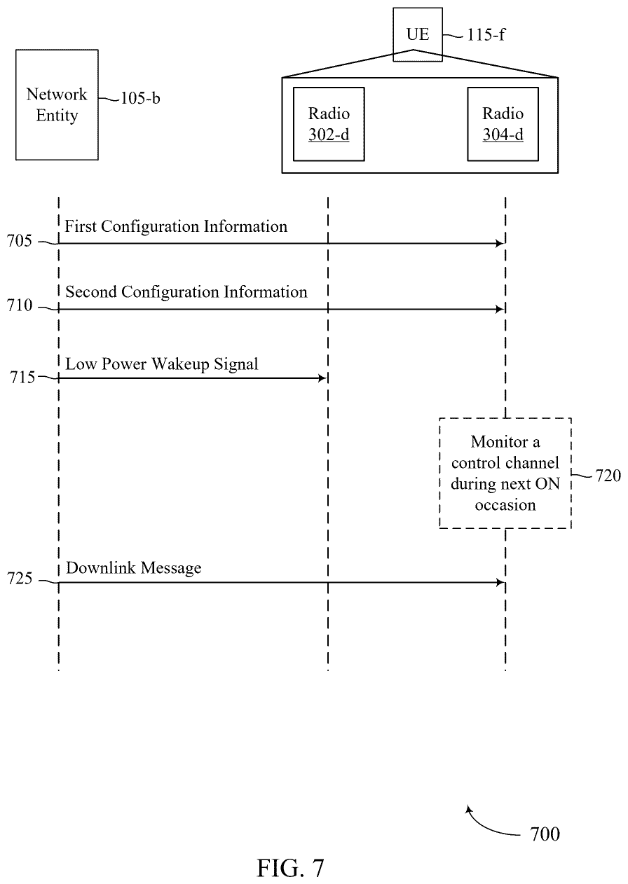

FIG. 7 shows an example of a process flow 700 that supports low power wakeup signaling in accordance with one or more aspects of the present disclosure. The process flow 700 may implement aspects of the wireless communications system 100 as described with reference to FIG. 1. The process flow 700 may implement or be implemented by aspects of the network architecture 200 as described herein with reference to FIG. 2. The process flow 700 may implement aspects of the wireless communications system 300 as described with reference to FIG. 3. The process flow 700 may implement or be implemented by 5G or radio access technologies beyond 5G.

The process flow 700 may include a network entity 105-b and a UE 115-f, which may be examples of a network entity and a UE as described herein. In the following description of the process flow 700, the operations between the network entity 105-b and the UE 115-f may be transmitted in a different order than the example order shown, or the operations performed by the network entity 105-b and the UE 115-f may be performed in different orders or at different times. Some operations may also be omitted from the process flow 700, and other operations may be added to the process flow 700.

In the example of FIG. 7, the UE 115-f may execute a set of instructions to control the functional elements (e.g., circuitry) of the UE 115-f to perform the described operations of the process flow 700. The UE 115-f may be examples of UEs as described with reference to FIGS. 1 through 6. Additionally, or alternatively, the UE 115-f may perform aspects of the described operations using a radio 302-d or a radio 304-d, which may be examples of a radio 302 and a radio 304 as described with reference to FIGS. 3 through 6.

For example, the UE 115-f may be equipped with multiple radios, such as the radio 302-d and the radio 304-d to support various operations (e.g., receiving, obtaining, monitoring, outputting, transmitting). The radio 302-d of the UE 115-f may be referred to as a low power radio, while the radio 304-d of the UE 115-f may be referred to as a main radio. The radio 302-d of the UE 115-f may be configured for monitoring and receiving one or more low power wakeup signals during one or more scheduled occasions as described herein with reference to FIGS. 3 through 6. The radio 304-d of the UE 115-f may be configured for monitoring and receiving one or more control channels (e.g., one or more PDCCH) during one or more scheduled ON durations as described herein with reference to FIGS. 3 through 6.

To achieve greater power savings at the UE 115-f, the radio 302-d of the UE 115-f may operate at a lower power level compared to the radio 304-d of the UE 115-f. For instance, the radio 302-d of the UE 115-f may be configured to receive and process signals with less complexity (e.g., signals with simpler waveforms, etc.) compared to the radio 304-d of the UE 115-f. Additionally, the radio 302-d of the UE 115-f may be designed to support efficient power toggling, enabling it to switch ON and OFF more effectively compared to the radio 304-d of the UE 115-f.

With reference to FIG. 7, at 705, the network entity 105-b may transmit and the UE 115-f may receive, via the radio 304-d of the UE 115-f, first configuration information that defines a first schedule of occasions for reception of a low power wakeup signal via the radio 302-d of the UE 115-f associated with low power operation. At 710, the network entity 105-b may transmit and the UE 115-f may receive, via the radio 304-d of the UE 115-f, second configuration information that defines a periodic C-DRX cycle that includes a second schedule of periodic ON durations to monitor a PDCCH via the radio 304-d of the UE 115-f different than the radio 302-d of the UE 115-f. At 715, the network entity 105-b may transmit and the UE 115-f may receive, via the radio 302-d of the UE 115-f, a low power wakeup signal in accordance with the first configuration information and in advance of, by at least a threshold amount, a start of a next ON duration or a next PDCCH message. At 720, the UE 115-f may optionally, monitor the PDCCH via the radio 304-d of the UE 115-f, for example, based on receiving the low power wakeup signal and in advance of, by at least the threshold amount, the start of the next ON duration or the next PDCCH message as described herein with reference to FIGS. 3 through 6. At 725, the network entity 105-b may transmit and the UE 115-f may receive, via the radio 304-d of the UE 115-f, downlink message (e.g., PDCCH message).

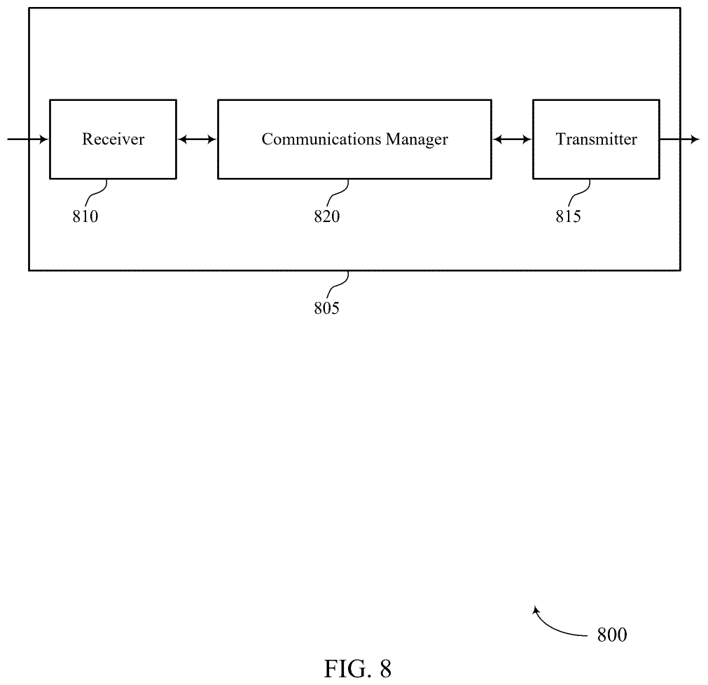

FIG. 8 shows a block diagram 800 of a device 805 that supports low power wakeup signaling in accordance with one or more aspects of the present disclosure. The device 805 may be an example of aspects of a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to low power wakeup signaling). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to low power wakeup signaling). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations or components thereof may be examples of means for performing various aspects of low power wakeup signaling as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for receiving first configuration information that defines a first schedule of occasions for reception of a low power wakeup signal via a first radio of the device 805 associated with low power operation. The communications manager 820 is capable of, configured to, or operable to support a means for receiving second configuration information that defines a periodic C-DRX cycle that includes a second schedule of periodic ON durations to monitor a PDCCH via a second radio of the device 805 different than the first radio of the device 805. The communications manager 820 is capable of, configured to, or operable to support a means for receiving the low power wakeup signal via the first radio of the device 805 in accordance with the first configuration information and in advance of, by at least a threshold amount, a start of a next ON duration or a next PDCCH message.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for reduced power consumption.

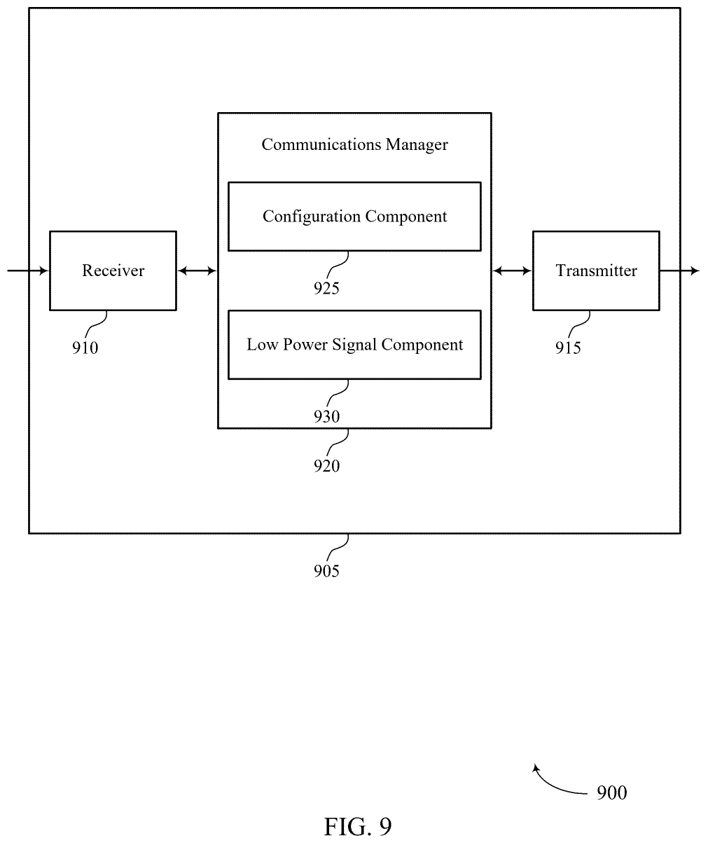

FIG. 9 shows a block diagram 900 of a device 905 that supports low power wakeup signaling in accordance with one or more aspects of the present disclosure. The device 905 may be an example of aspects of a device 805 or a UE 115 as described herein. The device 905 may include a receiver 910, a transmitter 915, and a communications manager 920. The device 905, or one of more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to low power wakeup signaling). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to low power wakeup signaling). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of low power wakeup signaling as described herein. For example, the communications manager 920 may include a configuration component 925 a low power signal component 930, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The configuration component 925 is capable of, configured to, or operable to support a means for receiving first configuration information that defines a first schedule of occasions for reception of a low power wakeup signal via a first radio of the device 905 associated with low power operation. The configuration component 925 is capable of, configured to, or operable to support a means for receiving second configuration information that defines a periodic C-DRX cycle that includes a second schedule of periodic ON durations to monitor a PDCCH via a second radio of the device 905 different than the first radio of the device 905. The low power signal component 930 is capable of, configured to, or operable to support a means for receiving the low power wakeup signal via the first radio of the device 905 in accordance with the first configuration information and in advance of, by at least a threshold amount, a start of a next ON duration or a next PDCCH message.

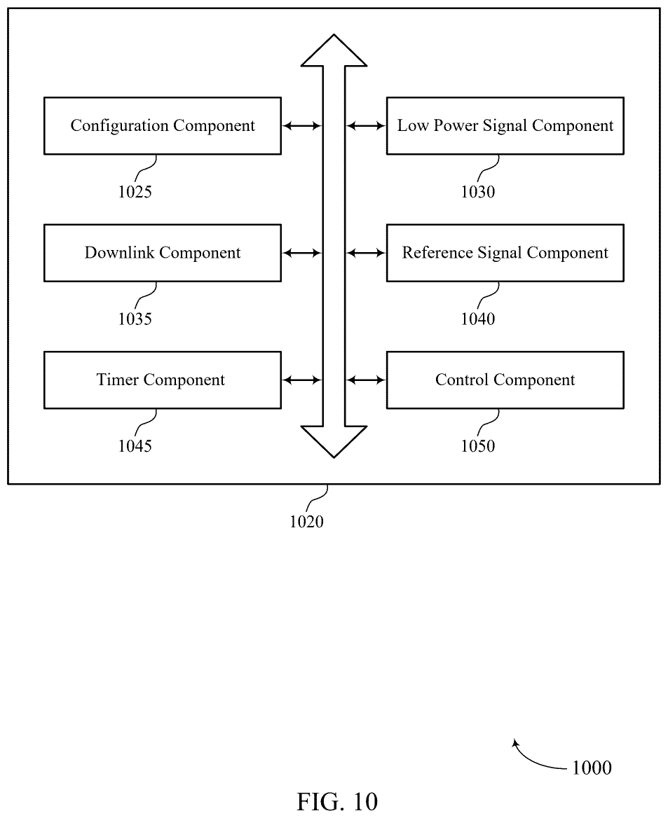

FIG. 10 shows a block diagram 1000 of a communications manager 1020 that supports low power wakeup signaling in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of low power wakeup signaling as described herein. For example, the communications manager 1020 may include a configuration component 1025, a low power signal component 1030, a downlink component 1035, a reference signal component 1040, a timer component 1045, a control component 1050, or any combination thereof. Each of these components, or components or subcomponents thereof (e.g., one or more processors, one or more memories), may communicate, directly or indirectly, with one another (e.g., via one or more buses).

The communications manager 1020 may support wireless communications in accordance with examples as disclosed herein. The configuration component 1025 is capable of, configured to, or operable to support a means for receiving first configuration information that defines a first schedule of occasions for reception of a low power wakeup signal via a first radio of the wireless device associated with low power operation. In some examples, the configuration component 1025 is capable of, configured to, or operable to support a means for receiving second configuration information that defines a periodic C-DRX cycle that includes a second schedule of periodic ON durations to monitor a PDCCH via a second radio of the wireless device different than the first radio of the wireless device. The low power signal component 1030 is capable of, configured to, or operable to support a means for receiving the low power wakeup signal via the first radio of the wireless device in accordance with the first configuration information and in advance of, by at least a threshold amount, a start of a next ON duration or a next PDCCH message.

In some examples, the downlink component 1035 is capable of, configured to, or operable to support a means for monitoring the PDCCH via the second radio of the wireless device during the next ON duration based on receipt of the low power wakeup signal via the first radio of the wireless device and in advance of, by at least the threshold amount, the start of the next ON duration or the next PDCCH message. In some examples, the downlink component 1035 is capable of, configured to, or operable to support a means for receiving the next PDCCH message via the second radio of the wireless device during the next ON duration based on the monitoring.

In some examples, the downlink component 1035 is capable of, configured to, or operable to support a means for monitoring the PDCCH via the second radio of the wireless device after the next ON duration based on receipt of the low power wakeup signal via the first radio of the wireless device within at least the threshold amount of the start of the next ON duration. In some examples, the downlink component 1035 is capable of, configured to, or operable to support a means for receiving the next PDCCH message via the second radio of the wireless device during a subsequent ON duration that occurs after the next ON duration.

In some examples, the low power wakeup signal includes at least one bit that indicates whether to monitor the PDCCH during the next ON duration.

In some examples, the downlink component 1035 is capable of, configured to, or operable to support a means for monitoring the PDCCH via the second radio of the wireless device during the next ON duration based on the at least one bit included in the received low power wakeup signal. In some examples, the downlink component 1035 is capable of, configured to, or operable to support a means for refraining (e.g., inhibiting, preventing, stopping, blocking, avoiding, skipping) from monitoring the PDCCH via the second radio of the wireless device during the next ON duration based on the at least one bit included in the received low power wakeup signal.

In some examples, the downlink component 1035 is capable of, configured to, or operable to support a means for monitoring the PDCCH via the second radio of the wireless device during the next ON duration irrespective of (e.g., regardless of, independent of) at least one bit included in the received low power wakeup signal.

In some examples, to support receiving the low power wakeup signal, the low power signal component 1030 is capable of, configured to, or operable to support a means for receiving the low power wakeup signal via the first radio of the wireless device in advance of, by at least the threshold amount, the next ON duration. In some examples, to support receiving the low power wakeup signal, the reference signal component 1040 is capable of, configured to, or operable to support a means for receiving a TRS via the second radio of the wireless device in accordance with third configuration information and in advance of the next ON duration.

In some examples, the third configuration information includes a TRS configuration. In some examples, the third configuration information is indicated by the low power wakeup signal.

In some examples, the reference signal component 1040 is capable of, configured to, or operable to support a means for transmitting a CSI report via the second radio of the wireless device during the next ON duration and irrespective of (e.g., regardless of, independent of) a timer for C-DRX.

In some examples, to support receiving the low power wakeup signal, the low power signal component 1030 is capable of, configured to, or operable to support a means for receiving the low power wakeup signal via the first radio of the wireless device in advance of the next ON duration. In some examples, to support receiving the low power wakeup signal, the downlink component 1035 is capable of, configured to, or operable to support a means for monitoring the PDCCH via the second radio of the wireless device for the next PDCCH message based on receipt of the low power wakeup signal via the first radio of the wireless device and in advance of the next PDCCH message.

In some examples, the downlink component 1035 is capable of, configured to, or operable to support a means for terminating (e.g., stopping, halting, ending, discontinuing, completing) monitoring the PDCCH via the second radio of the wireless device for the next PDCCH message based on an expiration of one or more of an inactivity timer, an ON duration timer for C-DRX, or an expiration of one or more timers associated with the low power wakeup signal.

In some examples, the control component 1050 is capable of, configured to, or operable to support a means for receiving control signaling from a network entity to terminate monitoring the PDCCH, where the control signaling includes DCI.

In some examples, to support receiving the low power wakeup signal, the low power signal component 1030 is capable of, configured to, or operable to support a means for receiving the low power wakeup signal via the first radio of the wireless device during an occasion of the first schedule of occasions and in advance of, by at least the threshold amount, the next PDCCH message during a current ON duration of the second schedule of periodic ON durations. In some examples, to support receiving the low power wakeup signal, the downlink component 1035 is capable of, configured to, or operable to support a means for monitoring the PDCCH via the second radio of the wireless device during the current ON duration and based on receipt of the low power wakeup signal in advance of, by at least the threshold amount, the next PDCCH message associated with the current ON duration. In some examples, to support receiving the low power wakeup signal, the downlink component 1035 is capable of, configured to, or operable to support a means for receiving the next PDCCH message via the second radio of the wireless device and during the current ON duration based on the monitoring.

In some examples, the timer component 1045 is capable of, configured to, or operable to support a means for enabling one or more of an inactivity timer or an ON duration timer for C-DRX based on receipt of the low power wakeup signal via the first radio of the wireless device.

In some examples, the downlink component 1035 is capable of, configured to, or operable to support a means for terminating (e.g., stopping, halting, ending, discontinuing, completing) monitoring the PDCCH via the second radio of the wireless device during the current ON duration based on an expiration of one or more of an inactivity timer or an ON duration timer for C-DRX.

In some examples, to support receiving the low power wakeup signal, the low power signal component 1030 is capable of, configured to, or operable to support a means for receiving the low power wakeup signal via the first radio of the wireless device during an occasion of the first schedule of occasions and in advance of, by at least the threshold amount, the next PDCCH message during a current ON duration of the second schedule of periodic ON durations. In some examples, to support receiving the low power wakeup signal, the reference signal component 1040 is capable of, configured to, or operable to support a means for receiving a TRS via the second radio of the wireless device in accordance with third configuration information and in advance of monitoring the PDCCH for the next PDCCH message during the current ON duration.

In some examples, the third configuration information includes a TRS configuration. In some examples, the third configuration information is indicated by the low power wakeup signal.

In some examples, the low power wakeup signal includes a OOK waveform.

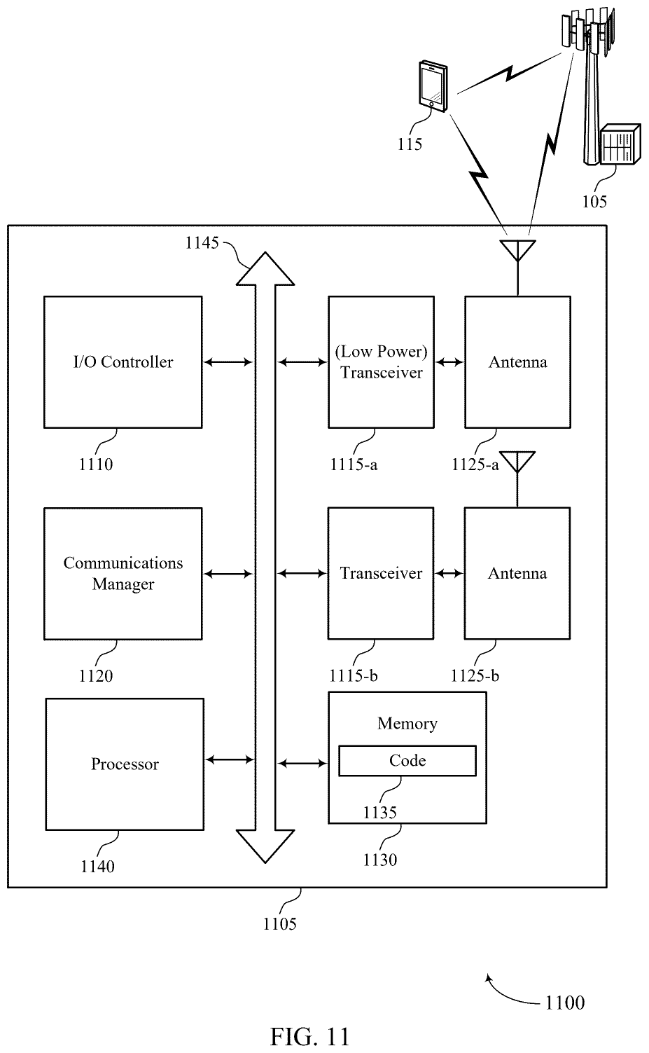

FIG. 11 shows a diagram of a system 1100 including a device 1105 that supports low power wakeup signaling in accordance with one or more aspects of the present disclosure. The device 1105 may be an example of or include components of a device 805, a device 905, or a UE 115 as described herein. The device 1105 may communicate (e.g., wirelessly) with one or more other devices (e.g., network entities 105, UEs 115, or a combination thereof). The device 1105 may include components for bi-directional voice and data communications including components for transmitting and receiving communications, such as a communications manager 1120, an input/output (I/O) controller, such as an I/O controller 1110, transceivers 1115 (e.g., a transceiver 1115-a, a transceiver 1115-b), one or more antennas 1125 (e.g., one or more antennas 1125-a, one or more antennas 1125-b), at least one memory 1130, code 1135, and at least one processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of one or more processors, such as the at least one processor 1140. In some cases, a user may interact with the device 1105 via the I/O controller 1110 or via hardware components controlled by the I/O controller 1110.

In some cases, the device 1105 may include a single antenna. However, in some other cases, the device 1105 may have more than one antenna, which may be capable of concurrently transmitting or receiving multiple wireless transmissions. The transceivers 1115 may communicate bi-directionally via the one or more antennas 1125 using wired or wireless links as described herein. For example, the transceivers 1115 may represent a wireless transceiver and may communicate bi-directionally with another wireless transceiver. The transceivers 1115 may also include a modem to modulate the packets, to provide the modulated packets to one or more antennas 1125 for transmission, and to demodulate packets received from the one or more antennas 1125. The transceivers 1115, or the transceivers 1115 and one or more antennas 1125, may be an example of a transmitter 815, a transmitter 915, a receiver 810, a receiver 910, or any combination thereof or component thereof, as described herein. As described herein the device 1105 may be configured with a low power radio such as the transceiver 1115-a and antenna 1125-a, and a main radio such as the transceiver 1115-b and antenna 1125-b to support various operations described herein.

The at least one memory 1130 may include random access memory (RAM) and read-only memory (ROM). The at least one memory 1130 may store computer-readable, computer-executable, or processor-executable code, such as the code 1135. The code 1135 may include instructions that, when executed by the at least one processor 1140, cause the device 1105 to perform various functions described herein. The code 1135 may be stored in a non-transitory computer-readable medium such as system memory or another type of memory. In some cases, the code 1135 may not be directly executable by the at least one processor 1140 but may cause a computer (e.g., when compiled and executed) to perform functions described herein. In some cases, the at least one memory 1130 may include, among other things, a basic I/O system (BIOS) which may control basic hardware or software operation such as the interaction with peripheral components or devices.

The at least one processor 1140 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1140 may be configured to operate a memory array using a memory controller. In some other cases, a memory controller may be integrated into the at least one processor 1140. The at least one processor 1140 may be configured to execute computer-readable instructions stored in a memory (e.g., the at least one memory 1130) to cause the device 1105 to perform various functions (e.g., functions or tasks supporting low power wakeup signaling). For example, the device 1105 or a component of the device 1105 may include at least one processor 1140 and at least one memory 1130 coupled with or to the at least one processor 1140, the at least one processor 1140 and the at least one memory 1130 configured to perform various functions described herein.

In some examples, the at least one processor 1140 may include multiple processors and the at least one memory 1130 may include multiple memories. One or more of the multiple processors may be coupled with one or more of the multiple memories, which may, individually or collectively, be configured to perform various functions described herein. In some examples, the at least one processor 1140 may be a component of a processing system, which may refer to a system (such as a series) of machines, circuitry (including, for example, one or both of processor circuitry (which may include the at least one processor 1140) and memory circuitry (which may include the at least one memory 1130)), or components, that receives or obtains inputs and processes the inputs to produce, generate, or obtain a set of outputs. The processing system may be configured to perform one or more of the functions described herein. For example, the at least one processor 1140 or a processing system including the at least one processor 1140 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code 1135 (e.g., processor-executable code) stored in the at least one memory 1130 or otherwise, to perform one or more of the functions described herein.

The communications manager 1120 may support wireless communications in accordance with examples as disclosed herein. For example, the communications manager 1120 is capable of, configured to, or operable to support a means for receiving first configuration information that defines a first schedule of occasions for reception of a low power wakeup signal via a first radio of the device 1105 associated with low power operation. The communications manager 1120 is capable of, configured to, or operable to support a means for receiving second configuration information that defines a periodic C-DRX cycle that includes a second schedule of periodic ON durations to monitor a PDCCH via a second radio of the device 1105 different than the first radio of the device 1105. The communications manager 1120 is capable of, configured to, or operable to support a means for receiving the low power wakeup signal via the first radio of the device 1105 in accordance with the first configuration information and in advance of, by at least a threshold amount, a start of a next ON duration or a next PDCCH message.

By including or configuring the communications manager 1120 in accordance with examples as described herein, the device 1105 may support techniques for longer battery life.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the at least one processor 1140, the at least one memory 1130, the code 1135, or any combination thereof. For example, the code 1135 may include instructions executable by the at least one processor 1140 to cause the device 1105 to perform various aspects of low power wakeup signaling as described herein, or the at least one processor 1140 and the at least one memory 1130 may be otherwise configured to, individually or collectively, perform or support such operations.

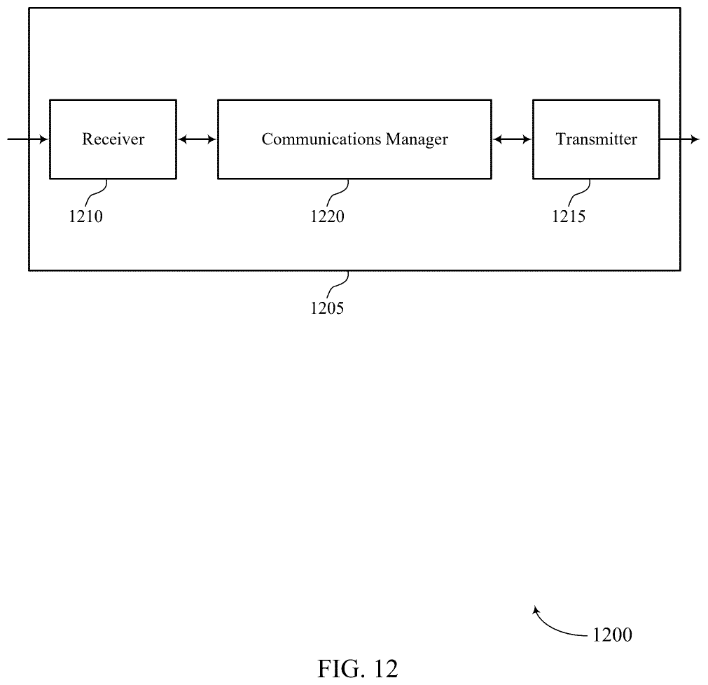

FIG. 12 shows a block diagram 1200 of a device 1205 that supports low power wakeup signaling in accordance with one or more aspects of the present disclosure. The device 1205 may be an example of aspects of a network entity 105 as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to, individually or collectively, support or enable the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The communications manager 1220, the receiver 1210, the transmitter 1215, or various combinations or components thereof may be examples of means for performing various aspects of low power wakeup signaling as described herein. For example, the communications manager 1220, the receiver 1210, the transmitter 1215, or various combinations or components thereof may be capable of performing one or more of the functions described herein.

In some examples, the communications manager 1220, the receiver 1210, the transmitter 1215, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1220, the receiver 1210, the transmitter 1215, or various combinations or components thereof may be implemented in code (e.g., as communications management software or firmware) executed by at least one processor (e.g., referred to as a processor-executable code). If implemented in code executed by at least one processor, the functions of the communications manager 1220, the receiver 1210, the transmitter 1215, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1220 may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. For example, the communications manager 1220 is capable of, configured to, or operable to support a means for transmitting first configuration information that defines a first schedule of occasions for reception of a low power wakeup signal via a first radio of a wireless device associated with low power operation. The communications manager 1220 is capable of, configured to, or operable to support a means for transmitting second configuration information that defines a periodic C-DRX cycle that includes a second schedule of periodic ON durations to monitor a PDCCH via a second radio of the wireless device different than the first radio of the wireless device. The communications manager 1220 is capable of, configured to, or operable to support a means for transmitting the low power wakeup signal via the first radio of the wireless device in accordance with the first configuration information and in advance of, by at least a threshold amount, a start of a next ON duration or a next PDCCH message.

By including or configuring the communications manager 1220 in accordance with examples as described herein, the device 1205 (e.g., at least one processor controlling or otherwise coupled with the receiver 1210, the transmitter 1215, the communications manager 1220, or a combination thereof) may support techniques for more efficient utilization of communication resources.

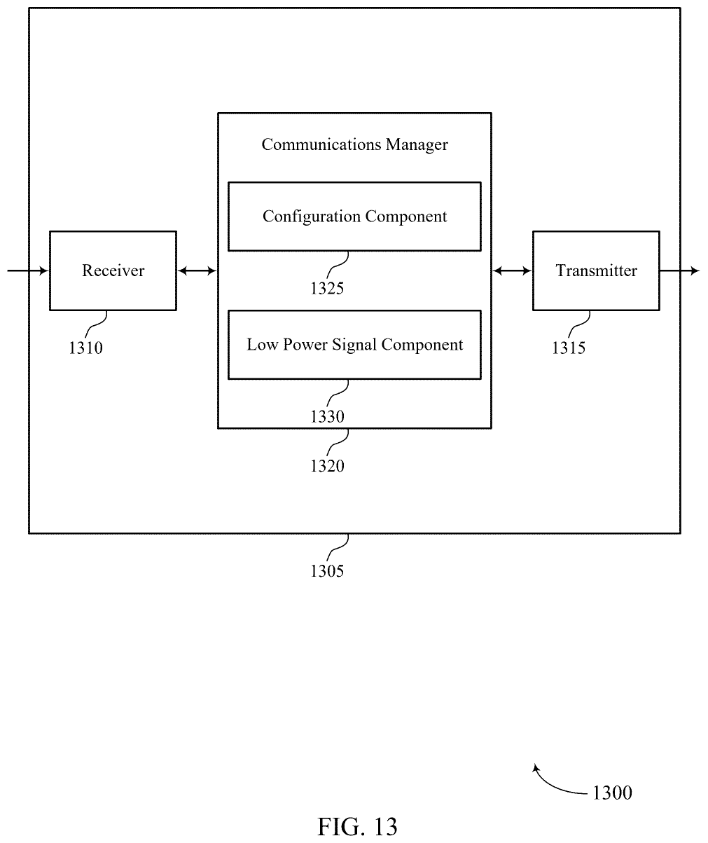

FIG. 13 shows a block diagram 1300 of a device 1305 that supports low power wakeup signaling in accordance with one or more aspects of the present disclosure. The device 1305 may be an example of aspects of a device 1205 or a network entity 105 as described herein. The device 1305 may include a receiver 1310, a transmitter 1315, and a communications manager 1320. The device 1305, or one of more components of the device 1305 (e.g., the receiver 1310, the transmitter 1315, the communications manager 1320), may include at least one processor, which may be coupled with at least one memory, to support the described techniques. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The device 1305, or various components thereof, may be an example of means for performing various aspects of low power wakeup signaling as described herein. For example, the communications manager 1320 may include a configuration component 1325 a low power signal component 1330, or any combination thereof. The communications manager 1320 may be an example of aspects of a communications manager 1220 as described herein. In some examples, the communications manager 1320, or various components thereof, may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications in accordance with examples as disclosed herein. The configuration component 1325 is capable of, configured to, or operable to support a means for transmitting first configuration information that defines a first schedule of occasions for reception of a low power wakeup signal via a first radio of a wireless device associated with low power operation. The configuration component 1325 is capable of, configured to, or operable to support a means for transmitting second configuration information that defines a periodic C-DRX cycle that includes a second schedule of periodic ON durations to monitor a PDCCH via a second radio of the wireless device different than the first radio of the wireless device. The low power signal component 1330 is capable of, configured to, or operable to support a means for transmitting the low power wakeup signal via the first radio of the wireless device in accordance with the first configuration information and in advance of, by at least a threshold amount, a start of a next ON duration or a next PDCCH message.

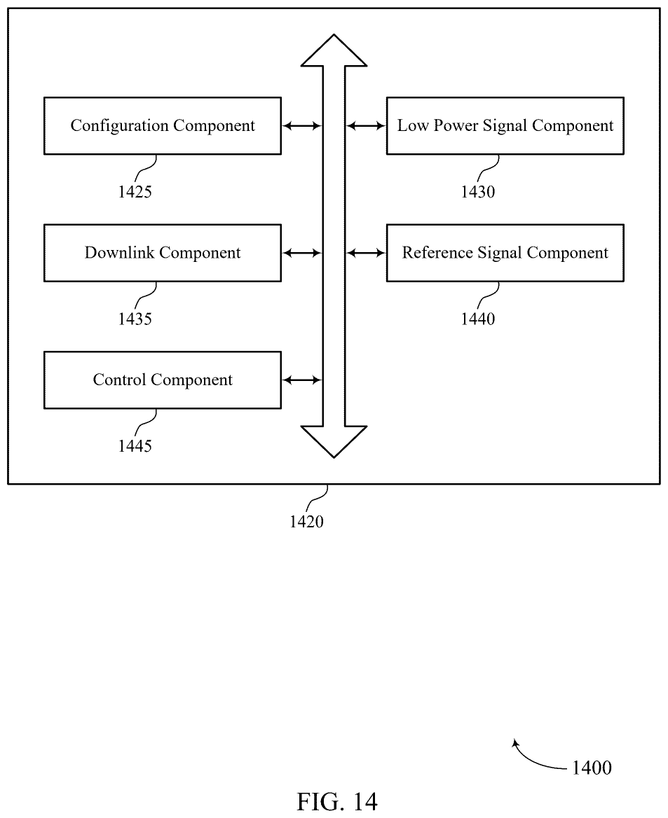

FIG. 14 shows a block diagram 1400 of a communications manager 1420 that supports low power wakeup signaling in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of low power wakeup signaling as described herein. For example, the communications manager 1420 may include a configuration component 1425, a low power signal component 1430, a downlink component 1435, a reference signal component 1440, a control component 1445, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1420 may support wireless communications in accordance with examples as disclosed herein. The configuration component 1425 is capable of, configured to, or operable to support a means for transmitting first configuration information that defines a first schedule of occasions for reception of a low power wakeup signal via a first radio of a wireless device associated with low power operation. In some examples, the configuration component 1425 is capable of, configured to, or operable to support a means for transmitting second configuration information that defines a periodic C-DRX cycle that includes a second schedule of periodic ON durations to monitor a PDCCH via a second radio of the wireless device different than the first radio of the wireless device. The low power signal component 1430 is capable of, configured to, or operable to support a means for transmitting the low power wakeup signal via the first radio of the wireless device in accordance with the first configuration information and in advance of, by at least a threshold amount, a start of a next ON duration or a next PDCCH message.

In some examples, the downlink component 1435 is capable of, configured to, or operable to support a means for transmitting the next PDCCH message during the next ON duration.

In some examples, the downlink component 1435 is capable of, configured to, or operable to support a means for transmitting the next PDCCH message during a subsequent ON duration that occurs after the next ON duration.

In some examples, the low power wakeup signal includes at least one bit that indicates whether to monitor the PDCCH during the next ON duration.

In some examples, to support transmitting the low power wakeup signal, the reference signal component 1440 is capable of, configured to, or operable to support a means for transmitting a TRS in accordance with third configuration information and in advance of the next ON duration.

In some examples, the third configuration information includes a TRS configuration. In some examples, the third configuration information is indicated by the low power wakeup signal.

In some examples, the reference signal component 1440 is capable of, configured to, or operable to support a means for receiving a CSI report during the next ON duration and irrespective of (e.g., regardless of, independent of) a timer for C-DRX.

In some examples, the control component 1445 is capable of, configured to, or operable to support a means for transmitting control signaling to terminate monitoring the PDCCH, where the control signaling includes DCI.

In some examples, the low power wakeup signal includes a OOK waveform.

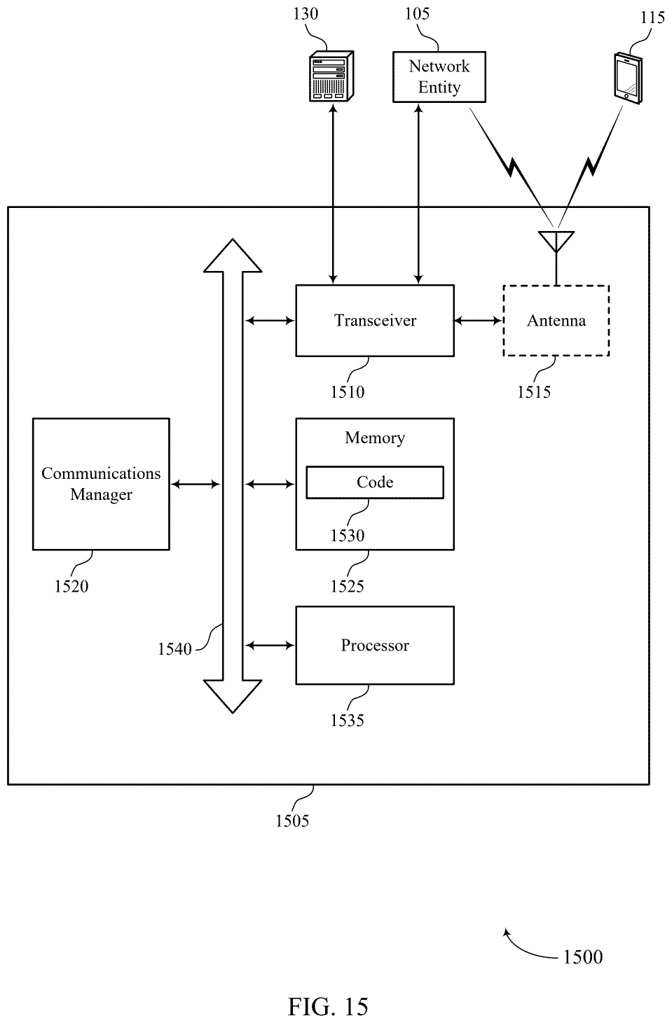

FIG. 15 shows a diagram of a system 1500 including a device 1505 that supports low power wakeup signaling in accordance with one or more aspects of the present disclosure. The device 1505 may be an example of or include components of a device 1205, a device 1305, or a network entity 105 as described herein. The device 1505 may communicate with other network devices or network equipment such as one or more of the network entities 105, UEs 115, or any combination thereof. The communications may include communications over one or more wired interfaces, over one or more wireless interfaces, or any combination thereof. The device 1505 may include components that support outputting and obtaining communications, such as a communications manager 1520, a transceiver 1510, one or more antennas 1515, at least one memory 1525, code 1530, and at least one processor 1535. These components may be in electronic communication or otherwise coupled (e.g., operatively, communicatively, functionally, electronically, electrically) via one or more buses (e.g., a bus 1540).

The transceiver 1510 may support bi-directional communications via wired links, wireless links, or both as described herein. In some examples, the transceiver 1510 may include a wired transceiver and may communicate bi-directionally with another wired transceiver. Additionally, or alternatively, in some examples, the transceiver 1510 may include a wireless transceiver and may communicate bi-directionally with another wireless transceiver. In some examples, the device 1505 may include one or more antennas 1515, which may be capable of transmitting or receiving wireless transmissions (e.g., concurrently). The transceiver 1510 may also include a modem to modulate signals, to provide the modulated signals for transmission (e.g., by one or more antennas 1515, by a wired transmitter), to receive modulated signals (e.g., from one or more antennas 1515, from a wired receiver), and to demodulate signals. In some implementations, the transceiver 1510 may include one or more interfaces, such as one or more interfaces coupled with the one or more antennas 1515 that are configured to support various receiving or obtaining operations, or one or more interfaces coupled with the one or more antennas 1515 that are configured to support various transmitting or outputting operations, or a combination thereof. In some implementations, the transceiver 1510 may include or be configured for coupling with one or more processors or one or more memory components that are operable to perform or support operations based on received or obtained information or signals, or to generate information or other signals for transmission or other outputting, or any combination thereof. In some implementations, the transceiver 1510, or the transceiver 1510 and the one or more antennas 1515, or the transceiver 1510 and the one or more antennas 1515 and one or more processors or one or more memory components (e.g., the at least one processor 1535, the at least one memory 1525, or both), may be included in a chip or chip assembly that is installed in the device 1505. In some examples, the transceiver 1510 may be operable to support communications via one or more communications links (e.g., communication link(s) 125, backhaul communication link(s) 120, a midhaul communication link 162, a fronthaul communication link 168).

The at least one memory 1525 may include RAM, ROM, or any combination thereof. The at least one memory 1525 may store computer-readable, computer-executable, or processor-executable code, such as the code 1530. The code 1530 may include instructions that, when executed by one or more of the at least one processor 1535, cause the device 1505 to perform various functions described herein. The code 1530 may be stored in a non-transitory computer-readable medium such as system memory or another type of memory. In some cases, the code 1530 may not be directly executable by a processor of the at least one processor 1535 but may cause a computer (e.g., when compiled and executed) to perform functions described herein. In some cases, the at least one memory 1525 may include, among other things, a BIOS which may control basic hardware or software operation such as the interaction with peripheral components or devices. In some examples, the at least one processor 1535 may include multiple processors and the at least one memory 1525 may include multiple memories. One or more of the multiple processors may be coupled with one or more of the multiple memories which may, individually or collectively, be configured to perform various functions herein (for example, as part of a processing system).

The at least one processor 1535 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1535 may be configured to operate a memory array using a memory controller. In some other cases, a memory controller may be integrated into one or more of the at least one processor 1535. The at least one processor 1535 may be configured to execute computer-readable instructions stored in a memory (e.g., one or more of the at least one memory 1525) to cause the device 1505 to perform various functions (e.g., functions or tasks supporting low power wakeup signaling). For example, the device 1505 or a component of the device 1505 may include at least one processor 1535 and at least one memory 1525 coupled with one or more of the at least one processor 1535, the at least one processor 1535 and the at least one memory 1525 configured to perform various functions described herein. The at least one processor 1535 may be an example of a cloud-computing platform (e.g., one or more physical nodes and supporting software such as operating systems, virtual machines, or container instances) that may host the functions (e.g., by executing code 1530) to perform the functions of the device 1505. The at least one processor 1535 may be any one or more suitable processors capable of executing scripts or instructions of one or more software programs stored in the device 1505 (such as within one or more of the at least one memory 1525).

In some examples, the at least one processor 1535 may include multiple processors and the at least one memory 1525 may include multiple memories. One or more of the multiple processors may be coupled with one or more of the multiple memories, which may, individually or collectively, be configured to perform various functions herein. In some examples, the at least one processor 1535 may be a component of a processing system, which may refer to a system (such as a series) of machines, circuitry (including, for example, one or both of processor circuitry (which may include the at least one processor 1535) and memory circuitry (which may include the at least one memory 1525)), or components, that receives or obtains inputs and processes the inputs to produce, generate, or obtain a set of outputs. The processing system may be configured to perform one or more of the functions described herein. For example, the at least one processor 1535 or a processing system including the at least one processor 1535 may be configured to, configurable to, or operable to cause the device 1505 to perform one or more of the functions described herein. Further, as described herein, being “configured to,” being “configurable to,” and being “operable to” may be used interchangeably and may be associated with a capability, when executing code stored in the at least one memory 1525 or otherwise, to perform one or more of the functions described herein.

In some examples, a bus 1540 may support communications of (e.g., within) a protocol layer of a protocol stack. In some examples, a bus 1540 may support communications associated with a logical channel of a protocol stack (e.g., between protocol layers of a protocol stack), which may include communications performed within a component of the device 1505, or between different components of the device 1505 that may be co-located or located in different locations (e.g., where the device 1505 may refer to a system in which one or more of the communications manager 1520, the transceiver 1510, the at least one memory 1525, the code 1530, and the at least one processor 1535 may be located in one of the different components or divided between different components).

In some examples, the communications manager 1520 may manage aspects of communications with a core network 130 (e.g., via one or more wired or wireless backhaul links). For example, the communications manager 1520 may manage the transfer of data communications for client devices, such as one or more UEs 115. In some examples, the communications manager 1520 may manage communications with one or more other network entities 105, and may include a controller or scheduler for controlling communications with UEs 115 (e.g., in cooperation with the one or more other network devices). In some examples, the communications manager 1520 may support an X2 interface within an LTE/LTE-A wireless communications network technology to provide communication between network entities 105.

The communications manager 1520 may support wireless communications in accordance with examples as disclosed herein. For example, the communications manager 1520 is capable of, configured to, or operable to support a means for transmitting first configuration information that defines a first schedule of occasions for reception of a low power wakeup signal via a first radio of a wireless device associated with low power operation. The communications manager 1520 is capable of, configured to, or operable to support a means for transmitting second configuration information that defines a periodic C-DRX cycle that includes a second schedule of periodic ON durations to monitor a PDCCH via a second radio of the wireless device different than the first radio of the wireless device. The communications manager 1520 is capable of, configured to, or operable to support a means for transmitting the low power wakeup signal via the first radio of the wireless device in accordance with the first configuration information and in advance of, by at least a threshold amount, a start of a next ON duration or a next PDCCH message.

By including or configuring the communications manager 1520 in accordance with examples as described herein, the device 1505 may support techniques for improved user experience related to reduced processing, more efficient utilization of communication resources, and improved coordination between devices.

In some examples, the communications manager 1520 may be configured to perform various operations (e.g., receiving, obtaining, monitoring, outputting, transmitting) using or otherwise in cooperation with the transceiver 1510, the one or more antennas 1515 (e.g., where applicable), or any combination thereof. Although the communications manager 1520 is illustrated as a separate component, in some examples, one or more functions described with reference to the communications manager 1520 may be supported by or performed by the transceiver 1510, one or more of the at least one processor 1535, one or more of the at least one memory 1525, the code 1530, or any combination thereof (for example, by a processing system including at least a portion of the at least one processor 1535, the at least one memory 1525, the code 1530, or any combination thereof). For example, the code 1530 may include instructions executable by one or more of the at least one processor 1535 to cause the device 1505 to perform various aspects of low power wakeup signaling as described herein, or the at least one processor 1535 and the at least one memory 1525 may be otherwise configured to, individually or collectively, perform or support such operations.

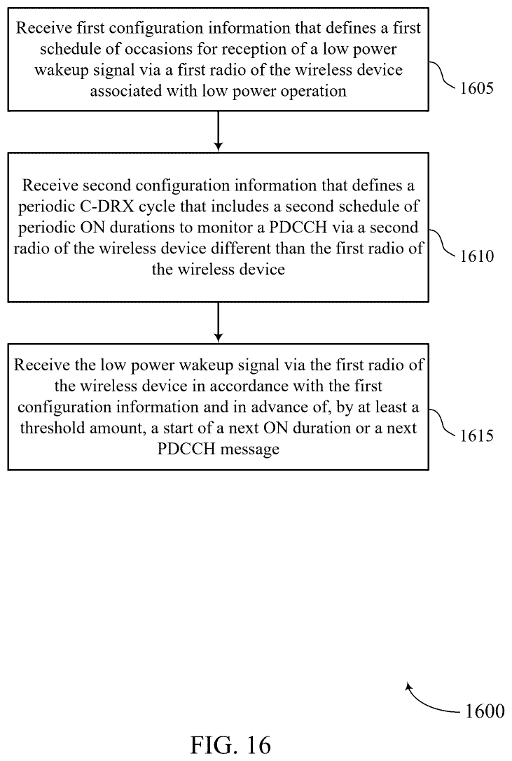

FIG. 16 shows a flowchart illustrating a method 1600 that supports low power wakeup signaling in accordance with one or more aspects of the present disclosure. The operations of the method 1600 may be implemented by a UE or its components as described herein. For example, the operations of the method 1600 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1605, the method may include receiving first configuration information that defines a first schedule of occasions for reception of a low power wakeup signal via a first radio of the wireless device associated with low power operation. The operations of 1605 may be performed in accordance with examples as disclosed herein. In some examples, aspects of the operations of 1605 may be performed by a configuration component 1025 as described with reference to FIG. 10.

At 1610, the method may include receiving second configuration information that defines a periodic C-DRX cycle that includes a second schedule of periodic ON durations to monitor a PDCCH via a second radio of the wireless device different than the first radio of the wireless device. The operations of 1610 may be performed in accordance with examples as disclosed herein. In some examples, aspects of the operations of 1610 may be performed by a configuration component 1025 as described with reference to FIG. 10.

At 1615, the method may include receiving the low power wakeup signal via the first radio of the wireless device in accordance with the first configuration information and in advance of, by at least a threshold amount, a start of a next ON duration or a next PDCCH message. The operations of 1615 may be performed in accordance with examples as disclosed herein. In some examples, aspects of the operations of 1615 may be performed by a low power signal component 1030 as described with reference to FIG. 10.

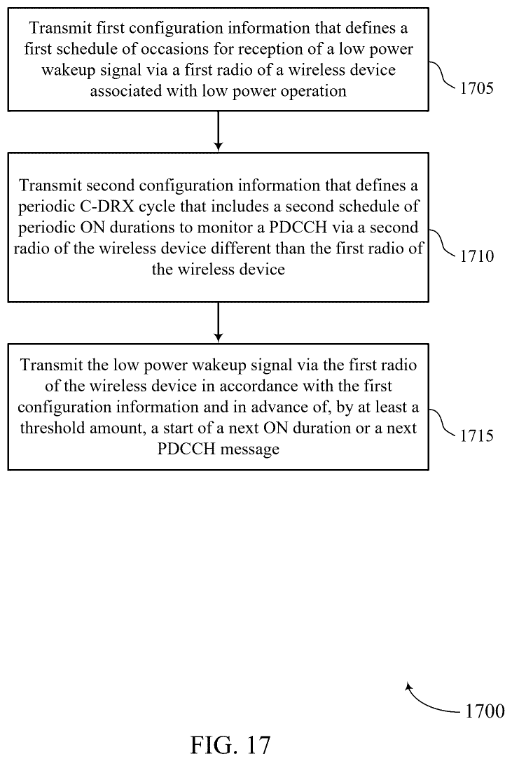

FIG. 17 shows a flowchart illustrating a method 1700 that supports low power wakeup signaling in accordance with one or more aspects of the present disclosure. The operations of the method 1700 may be implemented by a network entity or its components as described herein. For example, the operations of the method 1700 may be performed by a network entity as described with reference to FIGS. 1 through 7 and 12 through 15. In some examples, a network entity may execute a set of instructions to control the functional elements of the network entity to perform the described functions. Additionally, or alternatively, the network entity may perform aspects of the described functions using special-purpose hardware.

At 1705, the method may include transmitting first configuration information that defines a first schedule of occasions for reception of a low power wakeup signal via a first radio of a wireless device associated with low power operation. The operations of 1705 may be performed in accordance with examples as disclosed herein. In some examples, aspects of the operations of 1705 may be performed by a configuration component 1425 as described with reference to FIG. 14.

At 1710, the method may include transmitting second configuration information that defines a periodic C-DRX cycle that includes a second schedule of periodic ON durations to monitor a PDCCH via a second radio of the wireless device different than the first radio of the wireless device. The operations of 1710 may be performed in accordance with examples as disclosed herein. In some examples, aspects of the operations of 1710 may be performed by a configuration component 1425 as described with reference to FIG. 14.

At 1715, the method may include transmitting the low power wakeup signal via the first radio of the wireless device in accordance with the first configuration information and in advance of, by at least a threshold amount, a start of a next ON duration or a next PDCCH message. The operations of 1715 may be performed in accordance with examples as disclosed herein. In some examples, aspects of the operations of 1715 may be performed by a low power signal component 1430 as described with reference to FIG. 14.

It should be noted that the methods described herein describe possible implementations. The operations and the steps may be rearranged or otherwise modified and other implementations are possible. Further, aspects from two or more of the methods may be combined.

The following provides an overview of aspects of the present disclosure:
Aspect 1: A method for wireless communications at a wireless device, comprising: receiving first configuration information that defines a first schedule of occasions for reception of a low power wakeup signal via a first radio of the wireless device associated with low power operation; receiving second configuration information that defines a periodic C-DRX cycle that includes a second schedule of periodic ON durations to monitor a PDCCH via a second radio of the wireless device different than the first radio of the wireless device; and receiving the low power wakeup signal via the first radio of the wireless device in accordance with the first configuration information and in advance of, by at least a threshold amount, a start of a next ON duration or a next PDCCH message.
Aspect 2: The method of aspect 1, further comprising: monitoring the PDCCH via the second radio of the wireless device during the next ON duration based at least in part on receiving the low power wakeup signal via the first radio of the wireless device and in advance of, by at least the threshold amount, the start of the next ON duration or the next PDCCH message; and receiving the next PDCCH message via the second radio of the wireless device during the next ON duration based at least in part on the monitoring.
Aspect 3: The method of any of aspects 1 through 2, further comprising: monitoring the PDCCH via the second radio of the wireless device after the next ON duration based at least in part on receiving the low power wakeup signal via the first radio of the wireless device within at least the threshold amount of the start of the next ON duration; and receiving the next PDCCH message via the second radio of the wireless device during a subsequent ON duration that occurs after the next ON duration.
Aspect 4: The method of any of aspects 1 through 3, wherein the low power wakeup signal includes at least one bit that indicates whether to monitor the PDCCH during the next ON duration.
Aspect 5: The method of aspect 4, further comprising: monitoring the PDCCH via the second radio of the wireless device during the next ON duration based at least in part on the at least one bit included in the received low power wakeup signal; or refraining from monitoring the PDCCH via the second radio of the wireless device during the next ON duration based at least in part on the at least one bit included in the received low power wakeup signal.
Aspect 6: The method of aspect 5, further comprising: monitoring the PDCCH via the second radio of the wireless device during the next ON duration based at least in part on the at least one bit included in the received low power wakeup signal.
Aspect 7: The method of aspect 6, further comprising: refraining from monitoring the PDCCH via the second radio of the wireless device during the next ON duration based at least in part on the at least one bit included in the received low power wakeup signal.
Aspect 8: The method of any of aspects 4 through 5, further comprising: monitoring the PDCCH via the second radio of the wireless device during the next ON duration irrespective of at least one bit included in the received low power wakeup signal.
Aspect 9: The method of any of aspects 1 through 8, wherein receiving the low power wakeup signal comprises: receiving the low power wakeup signal via the first radio of the wireless device in advance of, by at least the threshold amount, the next ON duration, the method further comprising: receiving a TRS via the second radio of the wireless device in accordance with third configuration information and in advance of the next ON duration.
Aspect 10: The method of aspect 9, wherein the third configuration information comprises a TRS configuration, and the third configuration information is indicated by the low power wakeup signal.
Aspect 11: The method of any of aspects 1 through 10, further comprising: transmitting a CSI report via the second radio of the wireless device during the next ON duration and irrespective of a timer for C-DRX.
Aspect 12: The method of any of aspects 1 through 11, wherein receiving the low power wakeup signal comprises: receiving the low power wakeup signal via the first radio of the wireless device in advance of the next ON duration, the method further comprising: monitoring the PDCCH via the second radio of the wireless device for the next PDCCH message based at least in part on receiving the low power wakeup signal via the first radio of the wireless device and in advance of the next PDCCH message.
Aspect 13: The method of aspect 12, further comprising: terminating monitoring the PDCCH via the second radio of the wireless device for the next PDCCH message based at least in part on an expiration of one or more of an inactivity timer, an ON duration timer for C-DRX, or an expiration of one or more timers associated with the low power wakeup signal.
Aspect 14: The method of aspect 13, further comprising: receiving control signaling from a network entity to terminate monitoring the PDCCH, wherein the control signaling comprises DCI.
Aspect 15: The method of any of aspects 1 through 14, wherein receiving the low power wakeup signal comprises: receiving the low power wakeup signal via the first radio of the wireless device during an occasion of the first schedule of occasions and in advance of, by at least the threshold amount, the next PDCCH message during a current ON duration of the second schedule of periodic ON durations, the method further comprising: monitoring the PDCCH via the second radio of the wireless device during the current ON duration and based at least in part on receiving the low power wakeup signal in advance of, by at least the threshold amount, the next PDCCH message associated with the current ON duration; and receiving the next PDCCH message via the second radio of the wireless device and during the current ON duration based at least in part on the monitoring.
Aspect 16: The method of any of aspects 1 through 14, wherein receiving the low power wakeup signal comprises: receiving the low power wakeup signal via the first radio of the wireless device during an occasion of the first schedule of occasions and in advance of, by at least the threshold amount, the next PDCCH message during a current ON duration of the second schedule of periodic ON durations.
Aspect 17: The method of aspect 16, the method further comprising: monitoring the PDCCH via the second radio of the wireless device during the current ON duration and based at least in part on receiving the low power wakeup signal in advance of, by at least the threshold amount, the next PDCCH message associated with the current ON duration.
Aspect 18: The method of aspects 17, the method further comprising: receiving the next PDCCH message via the second radio of the wireless device and during the current ON duration based at least in part on the monitoring.
Aspect 19: The method of aspect 15, further comprising: enabling one or more of an inactivity timer or an ON duration timer for C-DRX based at least in part on receiving the low power wakeup signal via the first radio of the wireless device.
Aspect 20: The method of aspect 19, further comprising: terminating monitoring the PDCCH via the second radio of the wireless device during the current ON duration based at least in part on an expiration of one or more of an inactivity timer or an ON duration timer for C-DRX.
Aspect 21: The method of any of aspects 1 through 20, wherein receiving the low power wakeup signal comprises: receiving the low power wakeup signal via the first radio of the wireless device during an occasion of the first schedule of occasions and in advance of, by at least the threshold amount, the next PDCCH message during a current ON duration of the second schedule of periodic ON durations, the method further comprising: receiving a TRS via the second radio of the wireless device in accordance with third configuration information and in advance of monitoring the PDCCH for the next PDCCH message during the current ON duration.
Aspect 22: The method of aspect 21, wherein the third configuration information comprises a TRS configuration, and the third configuration information is indicated by the low power wakeup signal.
Aspect 23: The method of any of aspects 1 through 22, wherein the low power wakeup signal comprises a ON-OFF keying (OOK) waveform.
Aspect 24: A method for wireless communications at a network entity, comprising: transmitting first configuration information that defines a first schedule of occasions for reception of a low power wakeup signal via a first radio of a wireless device associated with low power operation; transmitting second configuration information that defines a periodic C-DRX cycle that includes a second schedule of periodic ON durations to monitor a PDCCH via a second radio of the wireless device different than the first radio of the wireless device; and transmitting the low power wakeup signal via the first radio of the wireless device in accordance with the first configuration information and in advance of, by at least a threshold amount, a start of a next ON duration or a next PDCCH message.
Aspect 25: The method of aspect 24, further comprising: transmitting the next PDCCH message during the next ON duration.
Aspect 26: The method of any of aspects 24 through 25, further comprising: transmitting the next PDCCH message during a subsequent ON duration that occurs after the next ON duration.
Aspect 27: The method of any of aspects 24 through 26, wherein the low power wakeup signal includes at least one bit that indicates whether to monitor the PDCCH during the next ON duration.
Aspect 28: The method of any of aspects 24 through 27, wherein transmitting the low power wakeup signal comprises: transmitting a TRS in accordance with third configuration information and in advance of the next ON duration.
Aspect 29: The method of aspect 28, wherein the third configuration information comprises a TRS configuration, and the third configuration information is indicated by the low power wakeup signal.
Aspect 30: The method of any of aspects 24 through 29, further comprising: receiving a CSI report during the next ON duration and irrespective of a timer for C-DRX.
Aspect 31: The method of any of aspects 24 through 30, further comprising: transmitting control signaling to terminate monitoring the PDCCH, wherein the control signaling comprises DCI.
Aspect 32: The method of any of aspects 24 through 31, wherein the low power wakeup signal comprises a ON-OFF keying (OOK) waveform.
Aspect 33: A wireless device for wireless communications, comprising one or more memories storing processor-executable code, and one or more processors coupled with the one or more memories and individually or collectively operable to execute the code to cause the wireless device to perform a method of any of aspects 1 through 23.
Aspect 34: A wireless device for wireless communications, comprising at least one means for performing a method of any of aspects 1 through 23.
Aspect 35: A non-transitory computer-readable medium storing code for wireless communications, the code comprising instructions executable by one or more processors to perform a method of any of aspects 1 through 23.
Aspect 36: A network entity for wireless communications, comprising one or more memories storing processor-executable code, and one or more processors coupled with the one or more memories and individually or collectively operable to execute the code to cause the network entity to perform a method of any of aspects 24 through 32.
Aspect 37: A network entity for wireless communications, comprising at least one means for performing a method of any of aspects 24 through 32.
Aspect 38: A non-transitory computer-readable medium storing code for wireless communications, the code comprising instructions executable by one or more processors to perform a method of any of aspects 24 through 32.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of (e.g., regardless of, independent of) the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
one or more memories; and
one or more processors coupled with the one or more memories and configured to cause the UE to:
receive first configuration information that defines a first schedule of occasions for reception of a low power wakeup signal via a first radio of the wireless device associated with low power operation;
receive second configuration information that defines a periodic connected-mode discontinuous reception cycle that includes a second schedule of periodic ON durations to monitor a physical downlink control channel via a second radio of the wireless device different than the first radio of the wireless device; and
receive the low power wakeup signal via the first radio of the wireless device in accordance with the first configuration information and in advance of, by at least a threshold amount, a start of a next ON duration or a next physical downlink control channel message.

2. The apparatus of claim 1, wherein the one or more processors are configured to cause the UE to:
monitor the physical downlink control channel via the second radio of the wireless device during the next ON duration based at least in part on receipt of the low power wakeup signal via the first radio of the wireless device and in advance of, by at least the threshold amount, the start of the next ON duration or the next physical downlink control channel message; and
receive the next physical downlink control channel message via the second radio of the wireless device during the next ON duration based at least in part on the monitoring.

3. The apparatus of claim 1, wherein the one or more processors are configured to cause the UE to:
monitor the physical downlink control channel via the second radio of the wireless device after the next ON duration based at least in part on receipt of the low power wakeup signal via the first radio of the wireless device within at least the threshold amount of the start of the next ON duration; and
receive the next physical downlink control channel message via the second radio of the wireless device during a subsequent ON duration that occurs after the next ON duration.

4. The apparatus of claim 1, wherein the low power wakeup signal includes at least one bit that indicates whether to monitor the physical downlink control channel during the next ON duration.

5. The apparatus of claim 4, wherein the one or more processors are configured to cause the UE to:
monitor the physical downlink control channel via the second radio of the wireless device during the next ON duration based at least in part on the at least one bit included in the received low power wakeup signal; or
refrain from monitoring the physical downlink control channel via the second radio of the wireless device during the next ON duration based at least in part on the at least one bit included in the received low power wakeup signal.

6. The apparatus of claim 4, wherein the one or more processors are configured to cause the UE to:
monitor the physical downlink control channel via the second radio of the wireless device during the next ON duration irrespective of at least one bit included in the received low power wakeup signal.

7. The apparatus of claim 1, wherein the one or more processors are configured to cause the UE to:
transmit a channel state information report via the second radio of the wireless device during the next ON duration and irrespective of a timer for connected-mode discontinuous reception.

8. The apparatus of claim 1, wherein, to receive the low power wakeup signal, the one or more processors are configured to cause the UE to:
receive the low power wakeup signal via the first radio of the wireless device in advance of the next ON duration, wherein the one or more processors are configured to cause the wireless device to:
monitor the physical downlink control channel via the second radio of the wireless device for the next physical downlink control channel message based at least in part on receipt of the low power wakeup signal via the first radio of the wireless device and in advance of the next physical downlink control channel message.

9. The apparatus of claim 8, wherein the one or more processors are configured to cause the UE to:
terminate monitoring the physical downlink control channel via the second radio of the wireless device for the next physical downlink control channel message based at least in part on an expiration of one or more of an inactivity timer, an ON duration timer for connected-mode discontinuous reception, or an expiration of one or more timers associated with the low power wakeup signal.

10. The apparatus of claim 1, wherein, to receive the low power wakeup signal, the one or more processors are configured to cause the UE to:
receive the low power wakeup signal via the first radio of the wireless device during an occasion of the first schedule of occasions and in advance of, by at least the threshold amount, the next physical downlink control channel message during a current ON duration of the second schedule of periodic ON durations, wherein the one or more processors are configured to cause the wireless device to:
monitor the physical downlink control channel via the second radio of the wireless device during the current ON duration and based at least in part on receipt of the low power wakeup signal in advance of, by at least the threshold amount, the next physical downlink control channel message associated with the current ON duration; and
receive the next physical downlink control channel message via the second radio of the wireless device and during the current ON duration based at least in part on the monitoring.

11. The apparatus of claim 10, wherein the one or more processors are configured to cause the UE to:
enable one or more of an inactivity timer or an ON duration timer for connected-mode discontinuous reception based at least in part on receipt of the low power wakeup signal via the first radio of the wireless device.

12. The apparatus of claim 11, wherein the one or more processors are configured to cause the UE to:
terminate monitoring the physical downlink control channel via the second radio of the wireless device during the current ON duration based at least in part on an expiration of one or more of an inactivity timer or an ON duration timer for connected-mode discontinuous reception.

13. An apparatus for wireless communication at a network entity, comprising:
one or more memories; and
one or more processors coupled with the one or more memories and configured to cause the network entity to:
transmit first configuration information that defines a first schedule of occasions for reception of a low power wakeup signal;
transmit second configuration information that defines a periodic connected-mode discontinuous reception cycle that includes a second schedule of periodic ON durations to monitor a physical downlink control channel; and
transmit the low power wakeup signal in accordance with the first configuration information and in advance of, by at least a threshold amount, a start of one of the periodic ON durations or a next physical downlink control channel message.

14. The apparatus of claim 13, wherein the one or more processors are configured to cause the network entity to:
transmit the next physical downlink control channel message during the next ON duration.

15. The apparatus of claim 13, wherein the one or more processors are configured to cause the network entity to:
transmit the next physical downlink control channel message during a subsequent ON duration that occurs after the one of the periodic ON durations.

16. The apparatus of claim 13, wherein the low power wakeup signal includes at least one bit that indicates whether to monitor the physical downlink control channel during the one of the periodic ON duration.

17. The apparatus of claim 13, wherein the one or more processors are configured to cause the network entity to:
receive a channel state information report during the one of the periodic ON durations and irrespective of a timer for connected-mode discontinuous reception.

18. A method for wireless communications at a wireless device, comprising:
receiving first configuration information that defines a first schedule of occasions for reception of a low power wakeup signal via a first radio of the wireless device associated with low power operation;
receiving second configuration information that defines a periodic connected-mode discontinuous reception cycle that includes a second schedule of periodic ON durations to monitor a physical downlink control channel via a second radio of the wireless device different than the first radio of the wireless device; and
receiving the low power wakeup signal via the first radio of the wireless device in accordance with the first configuration information and in advance of, by at least a threshold amount, a start of a next ON duration or a next physical downlink control channel message.

19. The method of claim 18, further comprising:
monitoring the physical downlink control channel via the second radio of the wireless device during the next ON duration based at least in part on receiving the low power wakeup signal via the first radio of the wireless device and in advance of, by at least the threshold amount, the start of the next ON duration or the next physical downlink control channel message; and
receiving the next physical downlink control channel message via the second radio of the wireless device during the next ON duration based at least in part on the monitoring.

20. The method of claim 18, further comprising:
monitoring the physical downlink control channel via the second radio of the wireless device after the next ON duration based at least in part on receiving the low power wakeup signal via the first radio of the wireless device within at least the threshold amount of the start of the next ON duration; and
receiving the next physical downlink control channel message via the second radio of the wireless device during a subsequent ON duration that occurs after the next ON duration.
